(19) United States
(12) Patent Application Publication
(10) Pub. No.: US 2025/0212144 A1
(43) Pub. Date: Jun. 26, 2025

(54) METHODS, SYSTEM, AND APPARATUS FOR LOW-POWER MODE COLLABORATIVE SYNCHRONIZATION

(71) Applicant: Huawei Technologies Co., Ltd., Shenzhen (CN)

(72) Inventors: Shahram Shahsavari, Ottawa (CA); Ahmed Wagdy Abdelwahab Shaban, Kanata (CA); Alireza Bayesteh, Brossard (CA)

(21) Appl. No.: 19/077,657

(22) Filed: Mar. 12, 2025

Related U.S. Application Data
(63) Continuation of application No. PCT/CN2022/118724, filed on Sep. 14, 2022.

(51) Int. Cl. H04W 56/00; H04B 1/69; H04W 8/22; H04W 24/10

(52) U.S. Cl. CPC H04W 56/0015; H04B 1/69; H04W 8/22; H04W 24/10; H04B 2001/6912

(57) ABSTRACT

Some embodiments of the present disclosure relate to using a chirp signal in a synchronization procedure of a wireless communication system. A synchronization chirp signal is received and processed, for synchronization purposes, by a user equipment (UE) in a low-power mode. The use of the synchronization chirp signal allows for low-complexity processing in the radio frequency (RF) analog domain. After the UE has interacted with the device that transmits the synchronization signal, the device that transmits the synchronization signal may report measurements to the network. As a consequence of receiving the measurement report, the network may be enabled to estimate timing advance for the UE.

### CROSS-REFERENCE TO RELATED APPLICATION

This application is a continuation of International Application No. PCT/CN2022/118724, filed on Sep. 14, 2022, the disclosure of which is hereby incorporated by reference in its entirety.

### TECHNICAL FIELD

The present disclosure relates, generally, to wireless communication and, in particular embodiments, to synchronization between devices in a wireless communication network and, even more particularly, to a collaborative synchronization for a device operating in a low-power mode.

### BACKGROUND

Known fifth generation (5G) new radio (NR) mobile wireless communication standards include definitions for operational “states” or “modes” in which user equipment (UE) may operate. When a UE is operating in one of two of the states, one of the states named “IDLE” and the other of the states named “INACTIVE,” the UE may be understood to be operating in a low-power mode. In each of these two states, the UE turns off circuitry that is deemed to be unnecessary. The turning off of such circuitry may be shown to successfully allow the UE to reduce power consumption. In contrast, the UE may also operate in a “CONNECTED” state, wherein power consumption is less of a concern.

Standards for sixth generation (6G) mobile wireless communication are, currently, a work-in-progress. Given the success of low-power modes for UEs that adhere to the 5G NR standards, it is expected that similar low-power modes will be part of 6G standards. Furthermore, it appears likely that new low-power modes will be defined in 6G standards. At least some of the new low-power modes may be expected to have constraints on power consumption that are even more stringent than the low-power modes defined in the 5G standards. Notably, it should be understood that the term “state” and the term “mode” may be used interchangeably, without a change in meaning of the underlying operation of a device.

In general, when a device is configured to operate in a low-power mode, device operations in the so-called radio frequency (RF) analog domain are preferred. It is known that digital processing circuitry is relatively highly power consuming, especially when the digital processing circuitry is operating at relatively high frequencies. Analog-to-digital converters (ADCs), which are among the known digital processing circuits that enable digital processing, are particularly known to be responsible for consumption of power.

### SUMMARY

Some embodiments of the present disclosure relate to using a chirp signal in a synchronization procedure. The chirp signal may be received and processed, for synchronization purposes, by a UE in a low-power mode. The use of the chirp signal allows for low-complexity processing in the RF analog domain. It is known that processing in the RF analog domain reduces power consumption relative to processing in the baseband digital domain. There are advantages that may be realized by transmitting the chirp signal from a device that is proximate to the UE. A proximate device has a minimal time-of-flight, thereby allowing for relatively accurate estimation of a synchronization offset. Use of a proximate device to transmit the chirp signal also allows for reuse of time-frequency resources for synchronization within a given network. A reduction of beam sweeping at the UE may also be shown to reduce power consumption at the UE and reduce processing complexity. After the UE has interacted with the device that transmits the synchronization signal, the device that transmits the synchronization signal may report measurements to the network. consequently, the network may be enabled to estimate timing advance for the UE.

Conventional synchronization techniques are known to involve beam sweeping and baseband digital processing. Both beam sweeping and baseband digital processing are known to be power consumptive.

Aspects of the present application feature relatively low power consumption. The relatively low power consumption is accomplished by carrying out a majority of processing in the RF analog domain and also by using proximity to relax the need for beam sweeping. Conveniently, aspects of the present application may be shown to achieve relatively low complexity and relatively high accuracy for estimation of synchronization offset estimation. Further conveniently, aspects of the present application may be shown to provide potential for UE multiplexing with relatively low time-frequency resource overhead.

According to an aspect of the present disclosure, there is provided a method for carrying out at a first device. The method includes receiving a chirp signal configuration, the chirp signal configuration including configuration information for a first chirp signal. The method further includes, while the first device is in a low-power mode of operation, receiving, from a second device, the first chirp signal, performing measurements on the first chirp signal to obtain an estimated synchronization offset between a first clock at the first device and a second clock at the second device and modifying, on the basis of the estimated synchronization offset, the first clock.

According to an aspect of the present disclosure, there is provided a first device. The first device includes a first clock and a receiver adapted to receive a chirp signal configuration, the chirp signal configuration including configuration information for a first chirp signal and receive, from a second device, the first chirp signal. The first device further includes a memory storing instructions and a processor caused, by executing the instructions while the first device is in a low-power mode of operation, to perform measurements on the first chirp signal to obtain an estimated synchronization offset between the first clock and a second clock at the second device and modify, on the basis of the estimated synchronization offset, the first clock.

According to an aspect of the present disclosure, there is provided a method for carrying out at a first device. The method includes receiving a chirp signal configuration, the chirp signal configuration including configuration information for a first chirp signal. The method further includes, while a second device is in a low-power mode of operation, transmitting, to the second device, the first chirp signal in accordance with the configuration information for the first chirp signal, receiving, from the second device, a second chirp signal, obtaining measurements on the second chirp signal to determine that the second chirp signal is intended for the first device and transmitting, to a third device, a measurement report based on the measurements on the second chirp signal.

According to an aspect of the present disclosure, there is provided a first device. The first device includes a receiver adapted to receive a chirp signal configuration, the chirp signal configuration including configuration information for a first chirp signal and receive, from a second device, a second chirp signal. The first device further includes a transmitter adapted to transmit, to the second device while the second device is in a low-power mode of operation, the first chirp signal in accordance with the configuration information for the first chirp signal, a memory storing instructions and a processor caused, by executing the instructions while the second device is in a low-power mode of operation, to obtain measurements on the second chirp signal to determine that the second chirp signal is intended for the first device and transmit, to a third device using the transmitter, a measurement report based on the measurements on the second chirp signal.

According to an aspect of the present disclosure, there is provided a method. The method includes transmitting, at a first device to a second device before the second device enters a low-power mode, configuration details for a first chirp signal, transmitting, to a third device, configuration details for a second chirp signal, receiving, from the third device, a report including a measurement made, at the third device, of the first chirp signal and processing the measurement.

According to an aspect of the present disclosure, there is provided a first device. The first device includes a transmitter adapted to transmit, to a second device before the second device enters a low-power mode, configuration details for a first chirp signal and transmit, to a third device, configuration details for a second chirp signal. The first device further includes a receiver adapted to receive, from the third device, a report including a measurement made, at the third device, of the first chirp signal, a memory storing instructions and a processor caused, by executing the instructions, to process the measurement.

According to an aspect of the present disclosure, there is provided a system comprising a first device and a second device. The first device is configured to transmit a first chirp signal. The second device is configured to receive the first chirp signal and obtain an estimated synchronization offset between a first clock at the first device and a second clock at the second device. The second device is further configured to transmit a second chirp signal to the first device to indicate an association between the first device and the second device.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a known structure for a synchronization signal (SS) block having four Orthogonal Frequency Division Multiplexing (OFDM) symbols;

FIG. 7 illustrates a known manner of promoting synchronization by transmitting SS blocks in different directions using different beams at different times;

FIG. 8 illustrates a known structure of a sidelink SS block for normal cyclic prefix OFDM;

FIG. 9 illustrates an example network including a plurality of user equipment (UE), including leader UEs and target UEs, associated with a transmit receive point (TRP), in accordance with aspects of the present application;

FIG. 10 illustrates access chirp signal transmission by target UEs in the example network illustrated in FIG. 9, in accordance with aspects of the present application;

FIG. 11 illustrates example steps of a method to be carried out by a target UE, in accordance with aspects of the present application;

FIG. 12 illustrates example steps of a method to be carried out by a leader UE, in accordance with aspects of the present application;

FIG. 13 illustrates example steps of a method to be carried out by a TRP, in accordance with aspects of the present application;

FIG. 14 illustrates, in a plot of frequency vs. time, a manner in which four synchronization chirp signal configuration parameters influence a synchronization chirp signal;

FIG. 15 illustrates, in a plot of frequency vs. time, a manner in which two more synchronization chirp signal configuration parameters influence a plurality of synchronization chirp signals;

FIG. 16 illustrates a first case, wherein starting frequency is used to differentiate a first synchronization chirp signal transmitted by a first leader UE from a second synchronization chirp signal transmitted by a second leader UE, in accordance with aspects of the present application;

FIG. 17 illustrates a second case, wherein starting time is used to differentiate a first synchronization chirp signal transmitted by a first leader UE from a second synchronization chirp signal transmitted by a second leader UE, in accordance with aspects of the present application; both starting frequency and starting time are used

FIG. 18 illustrates a third case, wherein both starting frequency and starting time are used to differentiate a first synchronization chirp signal transmitted by a first leader UE from a second synchronization chirp signal transmitted by a second leader UE, in accordance with aspects of the present application;

FIG. 19 illustrates an example where there are two leader UEs in the vicinity of a target UE that is in low-power mode;

FIG. 20 illustrates a rudimentary structure for two leader UEs and a target UE as well as a representation of synchronization chirp signals, the rudimentary structure for the target UE including a matched filter and a peak detector, in accordance with aspects of the present application;

FIG. 21 illustrates an example envelope of the output of the matched filter in FIG. 20, in accordance with aspects of the present application;

FIG. 22 illustrates steps in an example method of processing a received synchronization chirp signal, in accordance with aspects of the present application;

FIG. 23 illustrates example steps in a method of operation for a given leader UE with respect to access chirp signals, in accordance with aspects of the present application;

FIG. 24 illustrates transmission of an access chirp signal with a particular chirp rate, a particular starting frequency and a particular starting time, in accordance with aspects of the present application;

FIG. 25 illustrates a TRP, a target UE and a leader UE to which the target UE has associated itself, in accordance with aspects of the present application;

FIG. 26 illustrates, in a signal flow diagram, interaction between a leader UE, a TRP and a target UE, in accordance with aspects of the present application; and

FIG. 27 illustrates a linear model for synchronization offset with two model parameters.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

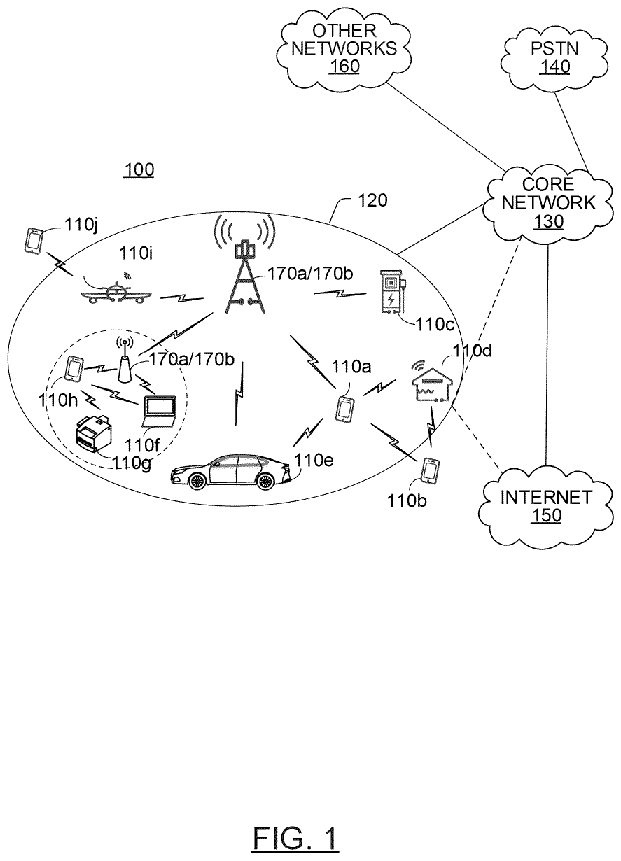

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

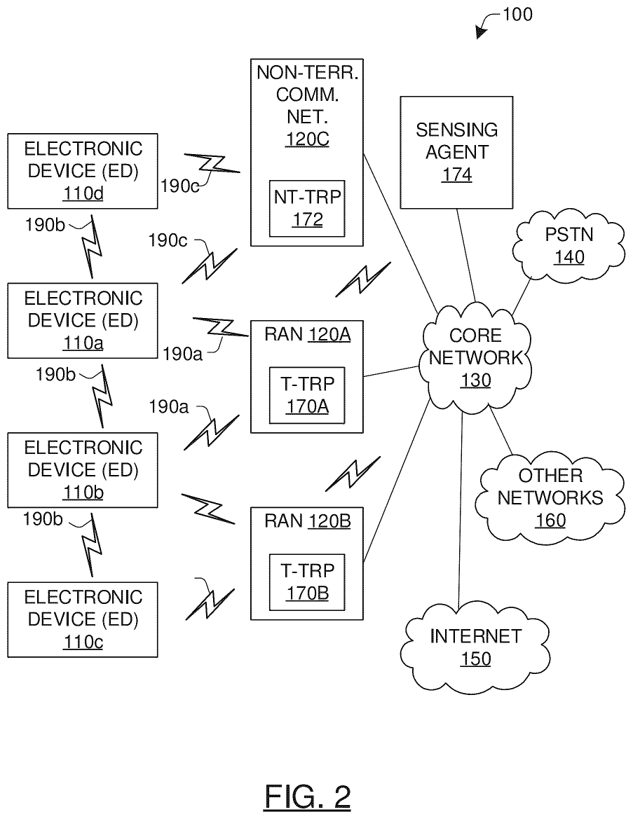

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

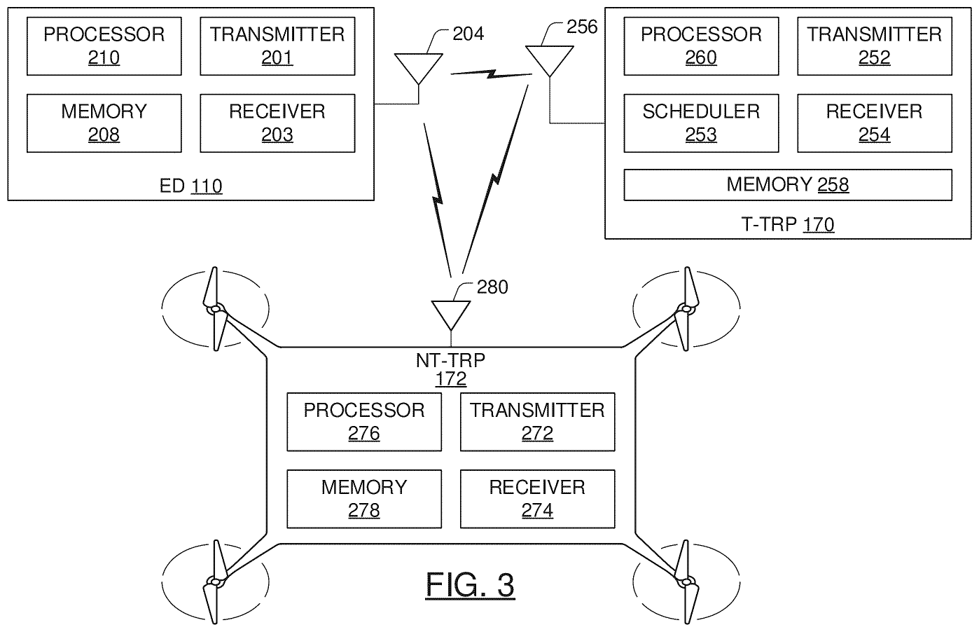

FIG. 3 illustrates another example of an ED 110 and a base station 170a, 170b and/or 170c. The ED 110 is used to connect persons, objects, machines, etc. The ED no may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs no may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED no connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random-access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example. The NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

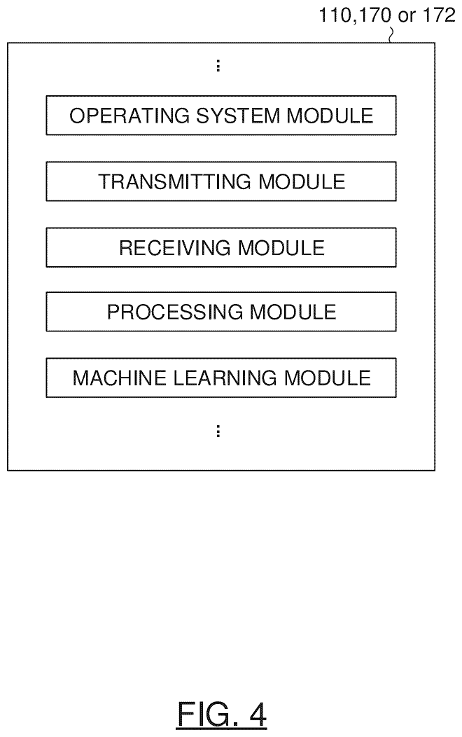

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

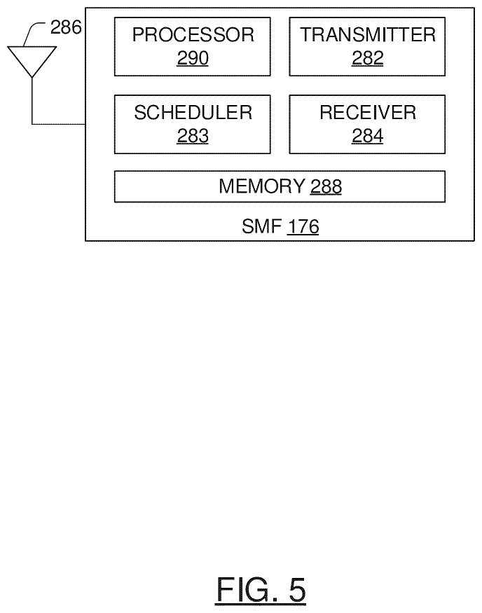

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE no) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth, B, and time duration, T. Such a linear chirp signal is generally known from its use in FMCW radar systems. A linear chirp signal is defined by an increase in frequency from an initial (starting) frequency, f_{chirp0}, at an initial (starting) time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

may be referenced as the “chirp slope” or “chirp rate.” The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

It is believed that, in future wireless systems (6G and beyond), various low-power mode procedures will rely upon what may be called “RF-dominant” processing. It has been discussed hereinbefore that, for low-power mode procedures, digital processing should be avoided to the extent that such avoidance is possible. Accordingly, it may be understood that RF-dominant processing may be expected to, largely, take place in the analog domain. However, it should also be clear that the processing may not be expected to take place entirely in the analog domain. Indeed, some level of digital, baseband processing may be deemed necessary. Such digital, baseband processing may be employed with a limited scope. Consequently, results of the digital processing may be understood to have limited accuracy. For example, an ADC may be employed with a low (e.g., sub-Nyquist) sampling rate to reduce power consumption relative to an ADC employed with a typical (e.g., Nyquist), or higher, sampling rate.

Examples of low-power mode procedures may include: low-power sensing; low-power positioning; low-power paging; and using backscattering for communication.

It may be shown that synchronization, between a UE 110 and a network entity with which the UE is to communicate (say, a TRP 170), enables the UE 110 to operate efficiently when the UE 110 is implementing so-called RF-dominant procedures.

Synchronization may be shown to allow the UE 110 to avoid a performance loss that may be shown to, otherwise, occur due to interference caused by synchronization offsets. Additionally, synchronization may be shown to facilitate resource management. Furthermore, synchronization may be shown to reduce operational complexity. Indeed, complex operations are known to be used to overcome a lack of synchronization in those instances wherein synchronization is not available.

When a UE 110, or another node, is operating in a low-power mode, a synchronization offset can increase due to the lack of communication activity. Therefore, it is important to devise approaches to compensate such offsets. Notably, synchronization is important when a UE 110 is in the CONNECTED state, in which state the UE 110 communicates data with one or more network entities. It follows that maintaining synchronization in a low-power mode can be useful to the UE 110 when the UE 110 is to transition into the CONNECTED state. Conveniently, some parameters, which may be computed as part of a synchronization procedure carried out in one of the low-power modes, need not be re-computed as the UE 110 transitions into the CONNECTED state.

Aspects of synchronization are addressed in the 5G NR wireless standard. In one aspect, synchronization for an access link between a UE 110 and a TRP 170 is addressed. In another aspect, synchronization for a sidelink connection between a first UE 110 and a second UE 110 is addressed. It may be shown that similar synchronization approaches are adopted in both of these two aspects (see A. Omri, M. Shaqfeh, A. Ali and H. Alnuweiri, “Synchronization Procedure in 5G NR Systems,” in IEEE Access, vol. 7, March 2019, pp. 41286-41295).

For a first scenario, in which a UE 110 is to be synchronized with a TRP 170, known Synchronization Signal (SS) blocks are defined in the time-frequency domain.

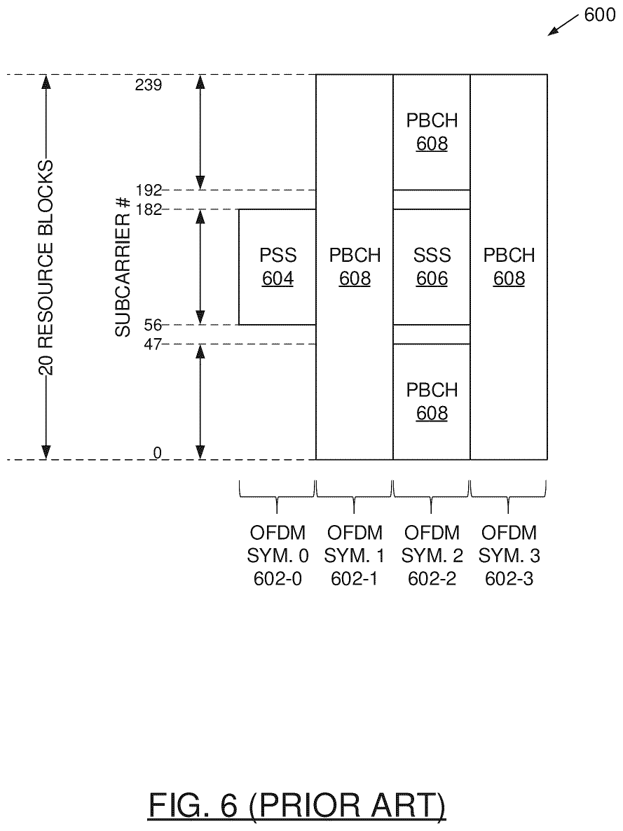

FIG. 6 illustrates a structure for an SS block 600 having four OFDM symbols 602-0, 602-1, 602-2, 602-3.

The SS block 600 includes a primary synchronization signal (PSS) part 604, a secondary synchronization signal (SSS) part 606 and a plurality of physical broadcast channel (PBCH) parts 608.

Once in a while, it may be expected that the TRP 170 will broadcast the SS block 600. A UE 110 that receives the SS block 600 may be shown to be able to estimate a synchronization offset between a clock at the UE 110 and a clock at the TRP 170.

The UE 110 may, responsively, take steps to synchronize the clock at the UE 110 with the clock at the TRP 170.

In the known 5G NR standard, a so-called M-sequence has been adopted for the PSS part 604 of the SS block 600. In the known 5G NR standard, a so-called Gold sequence has been adopted for the SSS part 606 of the SS block 600.

By measuring the received SS block 600 and by decoding the information inside the received SS block 600, the UE 110 may extract information, such as a cell ID, a frame number and an indication of allocation of resources. Note that, at the UE 110, extracting the information involves processing the received SS block 600 in the digital baseband domain.

At high frequencies, it is known that the TRP 170 may use directional transmissions with narrow beams. The use of narrow beams is a strategy that is used to combat the relatively high propagation path loss that is associated with the use of high frequencies. That is, in the context of high frequencies, use of directional, narrow-beam transmissions may be shown to be important to the task of providing reasonable service coverage within a given network.

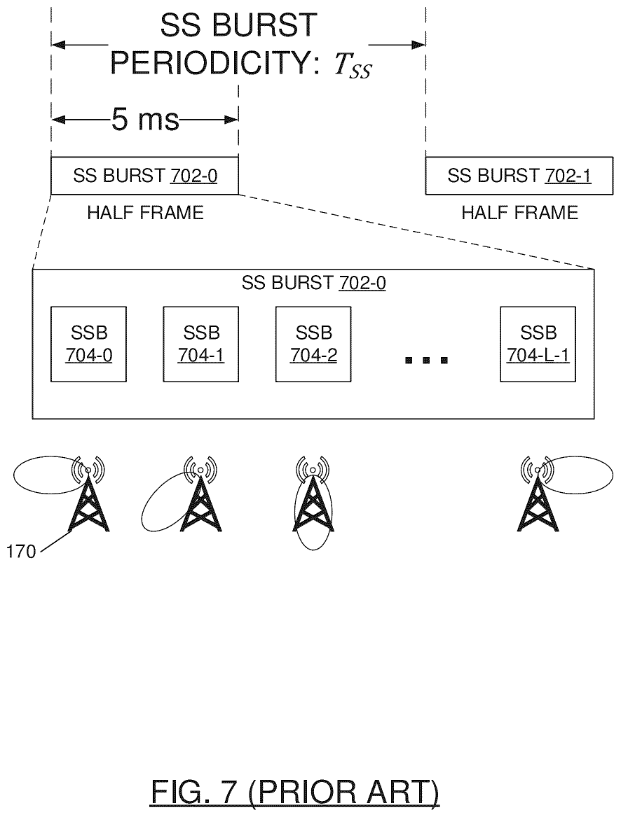

To promote synchronization, SS blocks may be transmitted, by a TRP 170, in different directions using different beams at different times, as illustrated in FIG. 7. Typically, SS blocks are organized into a SS burst. FIG. 7 illustrates a first SS burst 702-0 and a second SS burst 702-1. The beginning of the second SS burst 702-1 occurs a time duration, Tss, after the beginning of the first SS burst 702-0. The duration, Tss, may be called a SS burst periodicity. FIG. 7 illustrates that the first SS burst 702-0 includes a number, L, of SS blocks (SSBs) 704-0, 704-1, 704-2, . . . , 704-L-1 (collectively or individually referenced as 704). Each of the SSBs 704 is illustrated as being transmitted in a direction that is different from all the rest of the SSBs 704. The process of transmitting the SSBs in different directions is often referred to as “beam sweeping.”

Correspondingly, the UE 110 searches in different directions to attempt to receive and measure SSBs 704. The process of attempting to receive the SSBs in different directions is also often referred to as “beam sweeping.” It is notable that the beam sweeping procedure carried out at the UE 110 may be shown to involve increased resource overhead, increased complexity and increased power consumption relative to attempting to receive and measure SSBs in a known direction.

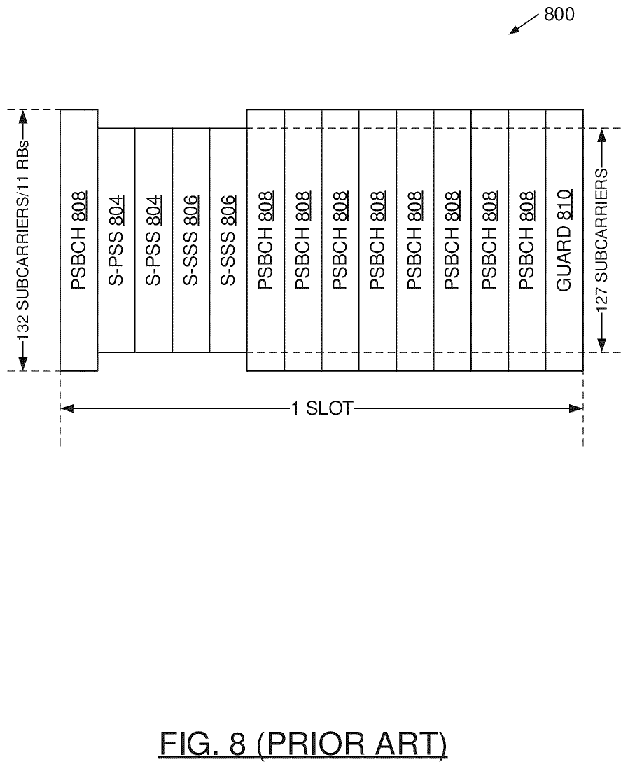

A similar approach has been adopted for sidelink synchronization. A “sidelink” is a link between two UEs and can be used for several reasons, such as to extend coverage of a service provided by a particular TRP 170 to UEs that are not directly covered by the particular TRP 170. In such scenarios, a first UE (a “master” UE), in the coverage of the particular TRP 170, may act as a relay node to allow a second UE (a “slave” UE), not in the coverage of the particular TRP 170, to connect the particular TRP 170. For sidelink synchronization, the master UE transmits sidelink synchronization signal (S-SS) blocks and the slave UE receives the S-SS blocks and measures a synchronization offset. FIG. 8 illustrates a structure of a sidelink SS block 800 for normal cyclic prefix OFDM. The structure illustrated in FIG. 8 has been adopted by the known 3rd Generation Partnership Project (3GPP) for the 5G NR standard. The sidelink SS block 800 contains 14 OFDM symbols and includes an S-PSS part 804, an S-SSS part 806, a plurality of PSBCH parts 808 and a guard part 810.

In the known 5G NR standard, an M-sequence has been adopted for the S-PSS part 804 of the S-SS block 800. In the known 5G NR standard, a Gold sequence has been adopted for the S-SSS part 806 of the S-SS block 800.

The slave UE may be expected to process received S-SS blocks in the digital baseband domain to, thereby, extract timing and information embedded in the S-SS blocks.

One major disadvantage of existing synchronization solutions is that the existing synchronization solutions involve relatively high power consumption. The relatively high power consumption may be blamed on intensive digital processing in the baseband domain. The relatively high power consumption may also be blamed on beam sweeping to combat high path loss at high frequencies. Notably, the main reason for existing synchronization solutions requiring digital baseband processing is that discrete sequences (e.g., the M-sequence and the Gold sequence) are used as the synchronization signal and such sequences are embedded in the OFDM symbols.

In overview, aspects of the present application relate to distributed, back-and-forth, short-range chirp signal transmission and measurement. In aspects of the present application, a UE in a low-power mode may be synchronized with a network entity with the help of one or more nearby UEs (or other nodes) that are in a connected state and, as a consequence of being in the connected state, are already synchronized with the network entity. The nearby UEs/nodes may be referenced as “leader” UEs/nodes. Notably, instead of “leader,” the name for the nearby UEs/nodes may be “master” UE/node, “prime” UE/node or “primary” UE/node, for just three alternate examples.

In aspects of the present application, a number of connected devices, which may be UEs or other network nodes, may be selected as leader UEs/nodes. The selection may, for example, be carried out at the TRP 170 after receipt of a capability report from a plurality of potential leader UEs/nodes.

A configuration of a “synchronization” chirp signal (transmitted by leader UEs/nodes) and a configuration of an “access” chirp signal (transmitted by so-called “target” UEs in low-power mode) may be transmitted, using control signaling, to the leader UEs/nodes as well as to the target UEs, before the target UEs enter the low-power mode. Subsequently, the leader UEs transmit synchronization chirp signals based on the relevant configuration. The UEs that are in low-power mode receive the synchronization chirp signals and perform measurements on the synchronization chirp signals to, thereby, extract timing of the received synchronization chirp signals. Extraction of the timing of the received synchronization chirp signals may be shown to allow the target UE to obtain an estimate of a synchronization offset. Upon obtaining the estimate of a synchronization offset, the target UE may take steps to reduce the synchronization offset.

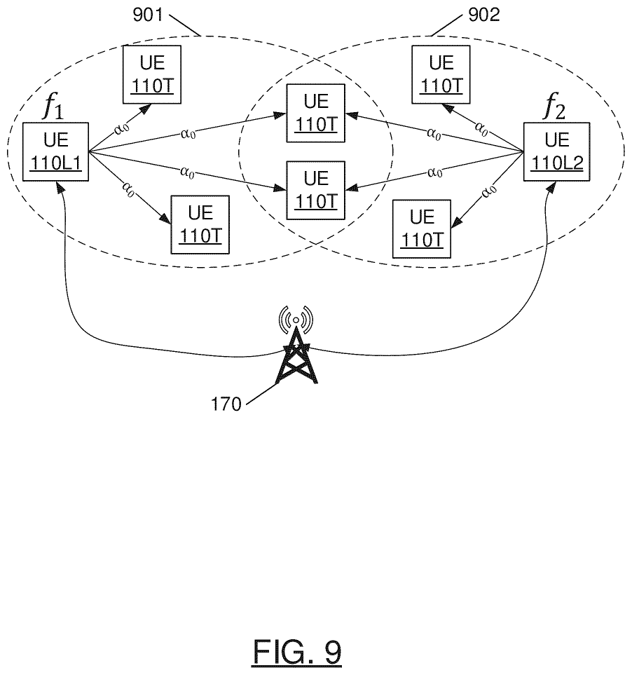

FIG. 9 illustrates a network including a plurality of UEs 110 associated with a TRP 170. The plurality of UEs 110 includes a first leader UE 110L1, a second leader UE 110L2 and six target UEs 110T. The leader UEs 110L1, 110L2 are in connected mode. The target UEs 110T are in low-power mode. The first leader UE 110L1 is associated with a first starting frequency, f₁, and a first coverage area 901. The second leader UE 110L2 is associated with a second starting frequency, f₂, and a second coverage area 902. FIG. 9 illustrates lines emanating from the first leader UE 110L1 and lines emanating from the second leader UE 110L2. The lines represent example transmissions of synchronization chirp signals by the leader UEs 110L1, 110L2. Each of the lines is associated with a chirp rate, α₀.

In FIG. 9, α₀, f₁ and f₂ are parts of the synchronization signal configuration. In the example illustrated in FIG. 9, the single chirp rate, α₀, is assigned for the synchronization signal transmitted by both leader UEs 110L1, 110L2. Furthermore, the synchronization chirp signals are transmitted at the same initial (starting) time, t_{chirp0}, but at different initial (starting) frequencies. The time duration, T, of each synchronization chirp signal is assumed to be the same.

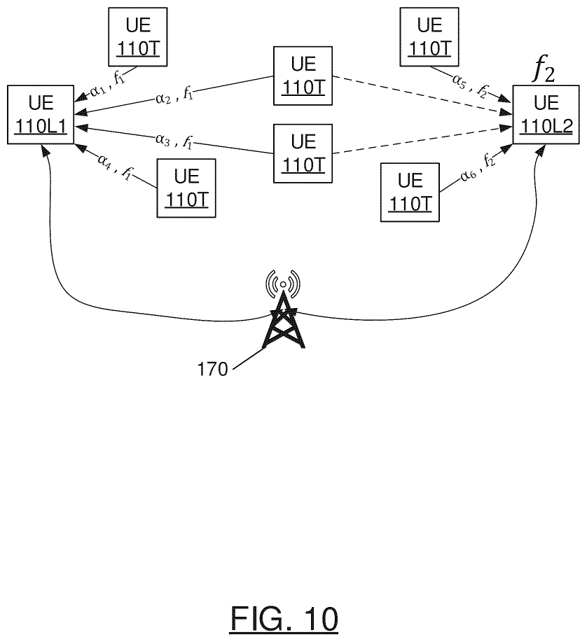

FIG. 10 illustrates access chirp signal transmission by the target UEs 110T in the example network illustrated in FIG. 9.

The target UEs 110T transmit access chirp signals based on a previously defined configuration, received when the target UEs 110T were in a connected state. The leader UEs 110L1, 110L2 receive and perform measurement on the access chirp signals to, thereby, estimate different parameters. In FIG. 10, the access chirp signals, transmitted by different target UEs 110T, are separated in the chirp rate domain. Furthermore, the starting frequency of the access chirp signals transmitted by each target UE 110T may be obtained, by each target UE 110T, from measurements done on the received synchronization signals. As illustrated in FIG. 10, four of the target UEs 110T transmit access chirp signals to the first leader UE 110L1 with the first starting frequency, f₁, and a unique one of four chirp rates, α₁, α₂, α₃, α₄. Also, as illustrated in FIG. 10, two of the target UEs 110T transmit access chirp signals to the second leader UE 110L2 with the second starting frequency, f₂, and a unique one of two chirp rates, α₅, α₆. Eventually, results of measurements of the access chirp signals are transmitted, by the leader UEs 110L1, 110L2 to the TRP 170 for further processing.

Conveniently, those aspects of the present application that are related to a chirp signal exchanging approach to achieving synchronization may be shown to enable RF-dominant processing, thereby reducing power consumption relative to the known baseband digital processing approach to achieving synchronization, discussed hereinbefore. As has been noted hereinbefore, aspects of the present application may involve some limited baseband processing after the RF-domain processing. Conveniently, the complexity of such baseband processing may be considered to be much lower than the complexity of pure baseband operation. Additionally, the chirp signal exchanging approach to achieving synchronization may be shown to enable a low-complexity version of synchronization offset estimation. For example, synchronization offset estimation may be accomplished using pulse compression or matched filtering while the target UE 110T is in low-power mode. Furthermore, each access chirp signal is configured with a parameter called a chirp rate, which can be used to multiplex more UEs as will be discussed later.

Conveniently, the chirp transmissions contemplated herein are short range and local. This is true of synchronization chirp signals contemplated herein and true of access chirp signals contemplated herein. The short range feature and the local feature may be shown to provide several benefits.

One benefit of the short range feature is that a parameter called a “time of flight” (ToF) is relatively small. Typically, a ToF term appears as an additive noise term when a device (e.g., a TRP 170 or a UE 110) is configured to estimate a synchronization offset on the basis of a single measurement. Consequently, the value for the estimated synchronization offset may be expressed as a sum of an actual synchronization offset and a ToF. Notably, however, because the ToF is small for scenarios contemplated herein, the dominant term in the estimated synchronization offset sum is the actual synchronization offset. Accordingly, the estimated synchronization offset sum is approximately equal to the actual synchronization offset. It follows that, by processing measurements of a received synchronization signal, a device may obtain an estimated synchronization offset sum that provides an approximation, with a reasonable level of accuracy, of an actual synchronization offset. Conveniently, the approximation of the actual synchronization offset is obtained without expending time and effort to compute the ToF.

As an example, if the short range, over which a chirp signal is transmitted, is 30 meters, then the ToF may be computed to be 0.1 microsecond. Accordingly, any estimated synchronization offset sum in the order of multiple microseconds may by understood to be within 0.1 microsecond of an actual synchronization offset.

Another benefit of the short range feature is that, since path loss is not large, omnidirectional transmission or wide-beam transmission may be expected to suffice for transmission of chirp signals. As a consequence, there is no need for beam sweeping. By avoiding the beam sweeping associated with known synchronization schemes, the overhead, complexity and power consumption associated with beam sweeping is also avoided.

A further benefit of the short range feature is that time/frequency resources may be spatially reused. Accordingly, a resource overhead associated with aspects of the present application is relatively small.

Aspects of the present application relate to interactions between and among three types of device.

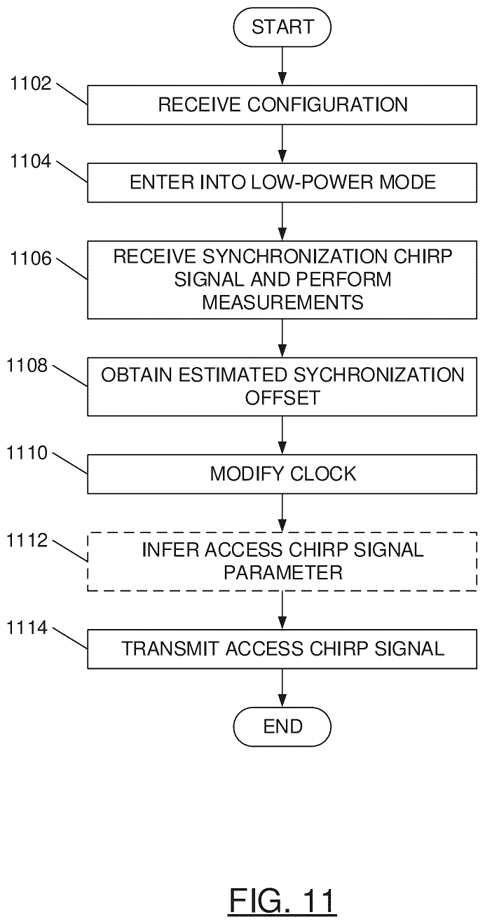

One type of device is the target UEs 110T (see FIGS. 9 and 10). The target UEs 110T, which may also be called terminal devices, are understood to be in low-power mode. The target UEs 110T enter into low-power mode to save energy. One objective of aspects of the present application is to synchronize the target UEs 110T with the TRP 170 while the target UEs 110T are in low-power mode. In aspects of the present application, the target UEs 110T are configured to carry out a method, example steps of which are illustrated in FIG. 11. Initially, the target UE 110T may receive (step 1102), from a TRP 170 and before entering low-power mode, a configuration for a synchronization chirp signal and a configuration for an access chirp signal. After entering (step 1104) into low-power mode, the target UE 110T may receive (step 1106), from a leader UE 110L, a synchronization chirp signal. The target UE 110T may also perform (step 1106) measurements on the received synchronization chirp signal to, thereby, obtain measurement results. The target UE 110T may next obtain (step 1108), by processing the measurement results, an estimated synchronization offset. The target UE 110T may then modify (step 1110), based on the estimated synchronization offset, a clock at the target UE 110T. The target UE 110T may, optionally, infer (step 1112), from the measurements of the received synchronization signal, a parameter to use when transmitting an access chirp signal. The target UE 110T may then transmit (step 1114), based on the configuration defined by the TRP 170, an access signal. The access chirp signal, transmitted in step 1114, may also be based on a parameter inferred in step 1112.

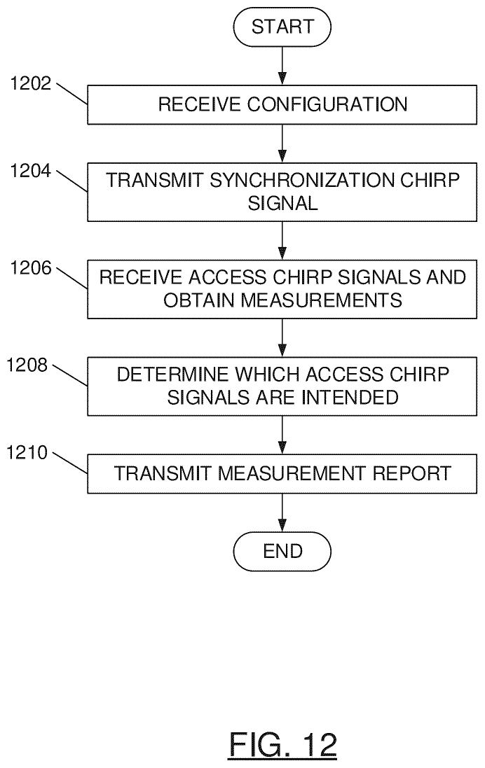

Another type of device is the leader UE 110L (see FIGS. 9 and 10). The leader UEs 110L may be understood to be UEs in CONNECTED state. The leader UEs 110L may, additionally or alternatively, be understood to be other network-controlled nodes defined with several objectives including facilitating synchronization for the target UEs 110T. In aspects of the present application, the leader UEs 110L are configured to carry out a method, example steps of which are illustrated in FIG. 12. Initially, the leader UEs 110L receive (step 1202), from a TRP 170, a configuration for a synchronization chirp signal and a configuration for an access chirp signal. A particular leader UE 110L may transmit (step 1204), based on the received configuration, the synchronization chirp signal. The particular leader UE 110L may then receive (step 1206), from target UEs 110T, access chirp signals. The particular leader UE 110L may, upon receiving (step 1206) the access chirp signals, perform measurements of timing and spatial direction of the received access chirp signals. The particular leader UE 110L may determine (step 1208), based on the obtained measurements, which of the access chirp signals, if any, are intended for the particular leader UE 110L. For specific access chirp signals that have been determined (step 1208) to be intended for the particular leader UE 110L, the particular leader UE 110L may transmit (step 1210), to the TRP 170, a measurement report that includes indications of the measurements associated with the specific access chirp signals.

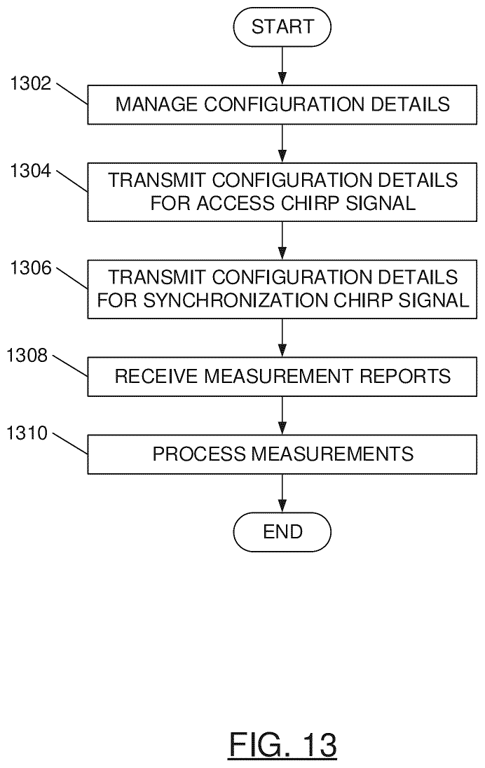

Another type of device is the TRP 170 (see FIGS. 1-4, 7, 9 and 10). In aspects of the present application, the TRPs 170 are configured to carry out a method, example steps of which are illustrated in FIG. 13. Initially, the TRP 170 may manage (step 1302) configuration details for the access chirp signals and configuration details for the synchronization chirp signals. The TRP 170 may then transmit (step 1304), to the target UEs 110T while the target UEs 110T are in a connected state, the configuration details for the access chirp signals and the configuration details for the synchronization chirp signals. The TRP 170 may also transmit (step 1306), to the leader UEs 110L, the configuration details for the access chirp signals and the configuration details for the synchronization chirp signals. Notably, there need not be a specific temporal order for step 1304 and step 1306. Upon receiving (step 1308) measurement reports from the leader UEs 110L, the TRP 170 may process (step 1310) the measurement included in the measurement reports to obtain desired quantities.

Aspects of the present application relate to configuration of the synchronization chirp signal. Recall that the synchronization chirp signal is transmitted (step 1204, FIG. 12) by each leader UE 110L. A specific configuration of the synchronization chirp signal may be managed (by the TRP 170, see step 1302, FIG. 13) for an i^{th} leader UE 110L. The specific configuration of the synchronization chirp signal may specify such parameters as: a chirp rate, αᵢ; a starting time, tᵢ; a time duration, Tᵢ; a starting frequency, fᵢ; a transmit power, Pᵢ; and representations for periodicity of the synchronization signal in time and frequency. The periodicity of the synchronization signal in time may be represented by a time period, \tilde{T}ᵢ. The periodicity of the synchronization signal in frequency may be represented by a frequency period, \tilde{F}ᵢ.

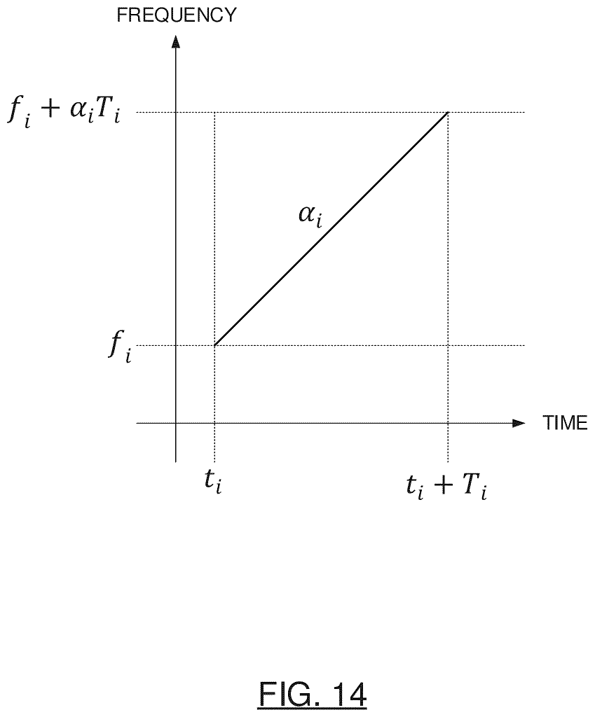

FIG. 14 illustrates a manner in which four of the synchronization chirp signal configuration parameters (αᵢ, tᵢ, Tᵢ and fᵢ) influence a synchronization chirp signal in a plot of frequency vs. time. The configuration parameters referenced in FIG. 14 correspond to configuration parameters in use when an i^{th} leader UE 110L-i transmits (step 1306) a synchronization chirp signal. Notably, a transmission range of the synchronization chirp signal transmitted (step 1306) by the i^{th} leader UE 110L-i may be adjusted by the TRP 170 tuning the transmit power, Pᵢ.

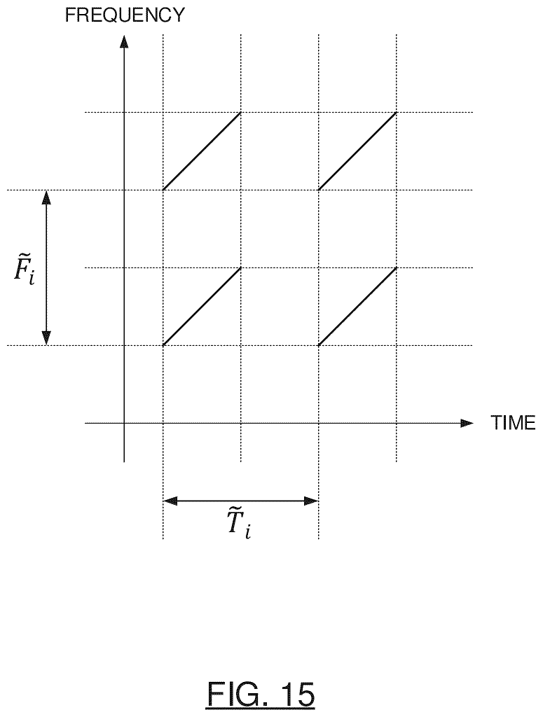

FIG. 15 illustrates a manner in which two of the synchronization chirp signal configuration parameters (\tilde{T}ᵢ and \tilde{F}ᵢ) influence a plurality of synchronization chirp signals in a plot of frequency vs. time.

General steps in a synchronization procedure practiced in a network with a TRP 170, a plurality of leader UEs 110L and a plurality of target UEs 110T are as follows.

The TRP 170 transmits (step 1306, FIG. 13), to the leader UEs 110L, the configuration details for the access chirp signals and the configuration details for respective synchronization chirp signals. The TRP 170 also transmits (step 1304, FIG. 13), to the target UEs 110T before the target UEs 110T enter the low-power mode, the configuration details for respective access chirp signals and the configuration details for the synchronization chirp signals. The transmission (steps 1304 and 1306, FIG. 13) of the configuration details may be carried out, by the TRP 170, using control signaling, such as RRC configuration signaling.

Each leader UE 110L transmits (step 1204, FIG. 12), to the target UEs 110T, synchronization chirp signals based on the received (step 1202, FIG. 12) configuration details.

At a representative target UE 110T, synchronization chirp signals are received (step 1106, FIG. 11) from nearby leader UEs 110L. The representative target UE 110T performs (step 1106, FIG. 11) measurements with RF-dominant processing to, thereby, obtain (step 1108, FIG. 11) timing of the received synchronization signals and, accordingly, a synchronization offset. The representative target UE 110T selects, based on the measurements, one of the leader UEs 110L and estimates (step 1108, FIG. 11) a synchronization offset with respect to the selected leader UE 110L. The representative target UE 110T may modify (step 1110, FIG. 11), based on the estimated synchronization offset, a clock at the representative target UE 110T. The representative target UE 110T may infer (step 1112, FIG. 11), from the measurements of the received synchronization signal, a parameter to use when transmitting an access chirp signal.

The plurality of leader UEs 110L may not be synchronized with each other. The TRP 170 may have an ability to compensate for any synchronization offset among various leader UEs 110L through managing (step 1302, FIG. 13) the synchronization chirp signal configuration. To this end, a starting time of the synchronization chirp signal may be set for each leader UE 110L in a manner that compensates for timing offsets among the plurality of leader UEs 110L. In this way, the TRP 170 may attempt to establish that the plurality of synchronization chirp signals will be transmitted (step 1304, FIG. 12), from the plurality of leader UEs 110L, at the same time with respect to a network clock. Notably, such synchronization provides some benefits (as will be explained hereinafter), such synchronization need not be considered mandatory. Two general scenarios are contemplated.

In a first scenario, it may be assumed that the leader UEs 110L are not synchronized. Accordingly, the leader UEs 110L may be understood to transmit the synchronization chirp signals with some time offsets with respect to the network clock.

In a second scenario, it may be assumed that the leader UEs 110L are synchronized. Accordingly, the leader UEs 110L may be understood to transmit the synchronization chirp signals at the same time with respect to the network clock.

In the first scenario, the synchronization task is best carried out when the target UE 110T is associated with a particular leader UE 110L for both the reception (step 1106, FIG. 11) of synchronization chirp signals and transmission (step 1114, FIG. 11) of access chirp signals. Consider that a given target UE 110T-X performs reception and measurement (step 1106, FIG. 11) on a synchronization chirp signal transmitted by a given leader UE 110L-Y. On the basis of the measurements, the given target UE 110T-X may estimate (step 1108, FIG. 11) a synchronization offset with respect to the given leader UE 110L-Y. It follows that the synchronization task is best carried out in view of the access chirp signal transmitted (step 1114, FIG. 11) by the given target UE 110T-X being received (step 1206) and measured by the given leader UE 110L-Y.

One strategy for enabling the target UE 110T to be associated with a particular leader UE 110L for both the reception (step 1106, FIG. 11) of synchronization chirp signals and transmission (step 1114, FIG. 11) of access chirp signals, involves establishing that the configuration of each synchronization chirp signal is specific to the leader UE 110L that transmits the synchronization chirp signal. In this way, each synchronization chirp signal among a plurality of synchronization chirp signals received at the target UE 110T may be differentiated and associated, at the target UE 110T, with a particular leader UE 110L.

To differentiate the synchronization chirp signal transmitted by each leader UE 110L among a plurality of leader UEs 110L, the TRP 170 may configure each of the leader UEs 110L to use a different starting time, a different starting frequency, a different chirp rate or any combination of these parameters.

Notably, from a practical perspective, it may not be appealing to use different chirp rates to allow for differentiation of the synchronization chirp signal transmitted by different leader UEs 110L. As discussed hereinbefore, it is expected that the target UEs 110T are to perform measurement (step 1106, FIG. 11) on received synchronization chirp signals. It follows that, if each leader UE 110L is configured to use a different chirp rate when transmitting (step 1204, FIG. 12) synchronization chirp signals, the target UEs 110T will be expected to perform measurements (step 1106, FIG. 11) on received synchronization chirp signals with a variety of different chirp rates. In anticipation of allowing the target UEs 110T to perform measurements (step 1106, FIG. 11) on received synchronization chirp signals with a variety of different chirp rates, the hardware of the target UEs 110T may be configured for performing measurements (step 1106, FIG. 11) on received synchronization chirp signals with a variety of different chirp rates. It should be readily understood that hardware configured for performing measurements (step 1106, FIG. 11) on received synchronization chirp signals with only one chirp rate is less complex than hardware configured for performing measurements (step 1106, FIG. 11) on received synchronization chirp signals with a variety of different chirp rates. It should be additionally understood that hardware configured for performing measurements (step 1106, FIG. 11) on received synchronization chirp signals with only one chirp rate is likely to consume less power than hardware configured for performing measurements (step 1106, FIG. 11) on received synchronization chirp signals with a variety of different chirp rates.

Consequently, while it may be true that the use of different chirp rates, which allow for differentiation of the synchronization chirp signals transmitted by different leader UEs 110L, is possible, the focus, hereafter and for practical reasons, is on scenarios in which the chirp rate is the same for all synchronization chirp signals. In such scenarios, to allow for differentiation of the synchronization chirp signals transmitted by different leader UEs 110L, the TRP 170 may configure the different leader UEs 110L to expect chirp synchronization signals with different starting time and/or different starting frequency.

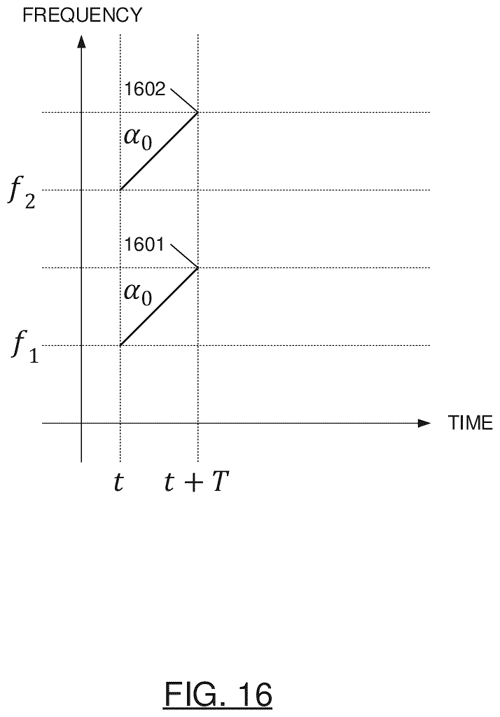

In a first case, illustrated in FIG. 16, starting frequency is used to differentiate a first synchronization chirp signal 1601 transmitted by a first leader UE from a second synchronization chirp signal 1602 transmitted by a second leader UE. That is, the first synchronization chirp signal 1601 has a first starting frequency, f₁, and the second synchronization chirp signal 1602 has a second starting frequency, f₂. Notably, the first synchronization chirp signal 1601 has a starting time, t, and the second synchronization chirp signal 1602 has the same starting time, t. Further notably, the first synchronization chirp signal 1601 has a chirp rate, α₀, and the second synchronization chirp signal 1602 has the same chirp rate, α₀.

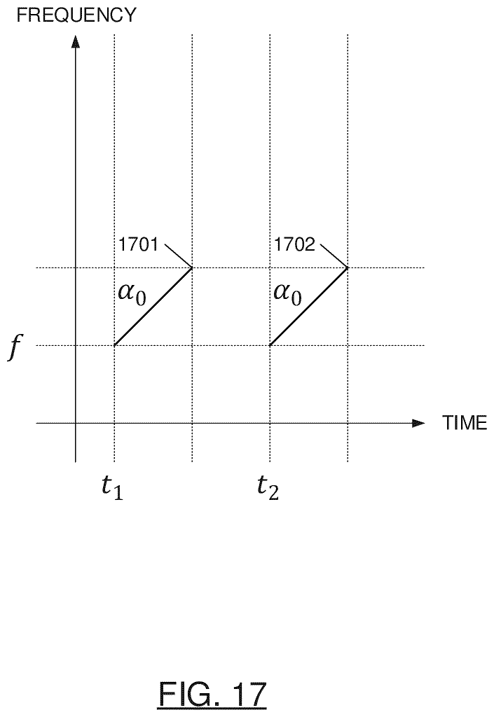

In a second case, illustrated in FIG. 17, starting time is used to differentiate a first synchronization chirp signal 1701 transmitted by a first leader UE from a second synchronization chirp signal 1702 transmitted by a second leader UE. That is, the first synchronization chirp signal 1701 has a first starting time, t₁, and the second synchronization chirp signal 1702 has a second starting time, t₂. Notably, the first synchronization chirp signal 1701 has a starting frequency, f, and the second synchronization chirp signal 1702 has the same starting frequency, f. Further notably, the first synchronization chirp signal 1701 has a chirp rate, α₀, and the second synchronization chirp signal 1702 has the same chirp rate, α₀.

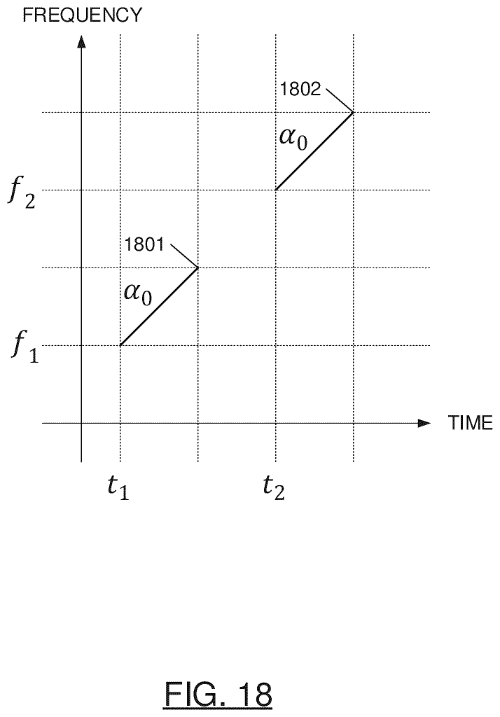

In a third case, illustrated in FIG. 18, both starting frequency and starting time are used to differentiate a first synchronization chirp signal 1801 transmitted by a first leader UE from a second synchronization chirp signal 1802 transmitted by a second leader UE. That is, the first synchronization chirp signal 1801 has a first starting time, t₁, and a first starting frequency, f₁. The second synchronization chirp signal 1802 has a second starting time, t₂, and a second starting frequency, f₂. Notably, the first synchronization chirp signal 1801 has a chirp rate, α₀, and the second synchronization chirp signal 1802 has the same chirp rate, α₀.

Enabling the target UE 110T to be associated with a particular leader UE 110L for both the reception (step 1106, FIG. 11) of synchronization chirp signals and transmission (step 1114, FIG. 11) of access chirp signals, may involve implementing a strategy that includes establishment of a connection between the configuration of the synchronization chirp signal and the configuration of the access chirp signal. Such a connection may be shown to help the particular leader UE 110L to identify which received access chirp signals, among a plurality of received access chirp signals, are intended for the particular leader UE 110L.

A first option, for this strategy, is to relate a starting frequency, f_{access}, of the access chirp signal to a starting frequency of the synchronization chirp signal. Using this first option, one result of the target UE 110T performing (step 1106, FIG. 11) measurements on a received synchronization chirp signal may be that the target UE 110T obtains a synchronization chirp signal starting frequency. The synchronization chirp signal starting frequency may be used, by the target UE 110T, to determine an access chirp signal starting frequency. For example, the target UE 110T may determine the access chirp signal starting frequency, f_{access}, to use when transmitting (step 1114, FIG. 11) the access chirp signal. The access chirp signal starting frequency, f_{access}, may be determined from a relationship that involves finding a sum of the chirp synchronization signal starting frequency, f_{synch}, and a constant frequency offset, f_{const}. That is, the access chirp signal starting frequency, f_{access}, may be determined from the relationship, f_{access}=f_{synch}+f_{const}. A value for the constant frequency offset, f_{const}, may be provided, by the TRP 170 to the target UE 110T, through control signaling at a time that precedes the target UE 110T entering into the low-power mode. The value for the constant frequency offset, f_{const}, may also be provided, by the TRP 170, to the leader UE 110L. Additionally, based on available values for the chirp synchronization signal starting frequency, f_{synch}, and the constant frequency offset, f_{const}, the leader UE 110L may be able to determine the access chirp signal starting frequency, f_{access}. Upon determining the access chirp signal starting frequency, f_{access}, the leader UE 110L may perform measurements on the access chirp signals received from the target UE 110T.

A second option, for this strategy, is to relate a starting time of the access chirp signal to a starting time of the synchronization chirp signal. Using this second option, one result of the target UE 110T performing (step 1106, FIG. 11) measurements on a received synchronization chirp signal may be that the target UE 110T obtains a synchronization chirp signal starting time. The access chirp signal starting time, t_{access}, may be determined from a relationship that involves finding a sum of the chirp synchronization signal starting time, t_{synch}, and a constant time offset, t_{const}. That is, the access chirp signal starting frequency, f_{access}, may be determined from the relationship, t_{access}=t_{synch}+t_{const}. A value for the constant time offset, t_{const}, may be provided, by the TRP 170 to the target UE 110T, through control signaling at a time that precedes the target UE 110T entering into the low-power mode. The value for the constant time offset, t_{const}, may also be provided, by the TRP 170, to the leader UE 110L. Additionally, based on available values for the synchronization chirp signal starting time, t_{synch}, and the constant time offset, t_{const}, the leader UE 110L may be able to determine the access chirp signal starting time, t_{access}. Upon determining the access chirp signal starting frequency, t_{access}, the leader UE 110L may perform measurements on the access chirp signals received from the target UE 110T.

A third option, for this strategy, is to relate the access chirp signal starting time to the synchronization chirp signal starting time and relate the access chirp signal starting frequency to the synchronization chirp signal starting frequency. Using this third option, one result of the target UE 110T performing (step 1106, FIG. 11) measurements on a received synchronization chirp signal may be that the target UE 110T obtains the synchronization chirp signal starting time and the synchronization chirp signal starting frequency. The access chirp signal starting time, t_{access}, and the access chirp signal starting frequency, f_{access}, may be determined from the relationships discussed hereinbefore. More generally, the access chirp signal starting time, t_{access}, may be a function of both the synchronization chirp signal starting time, t_{synch}, and the synchronization chirp signal starting frequency, f_{synch}. Similarly, the access chirp signal starting frequency, f_{access}, may be a function of both the synchronization chirp signal starting time, t_{synch}, and the synchronization chirp signal starting frequency, f_{synch}.

Notably, in all of the three options described hereinbefore, a part of the configuration of the access chirp signal may be inferred, at the target UE 110T, from measurement results obtained on a received synchronization chirp signal. It should be clear that, in such cases, the inferred part of the access chirp signal configuration need not be signaled to the target UE 110T before the target UE 110T enters into low-power mode.

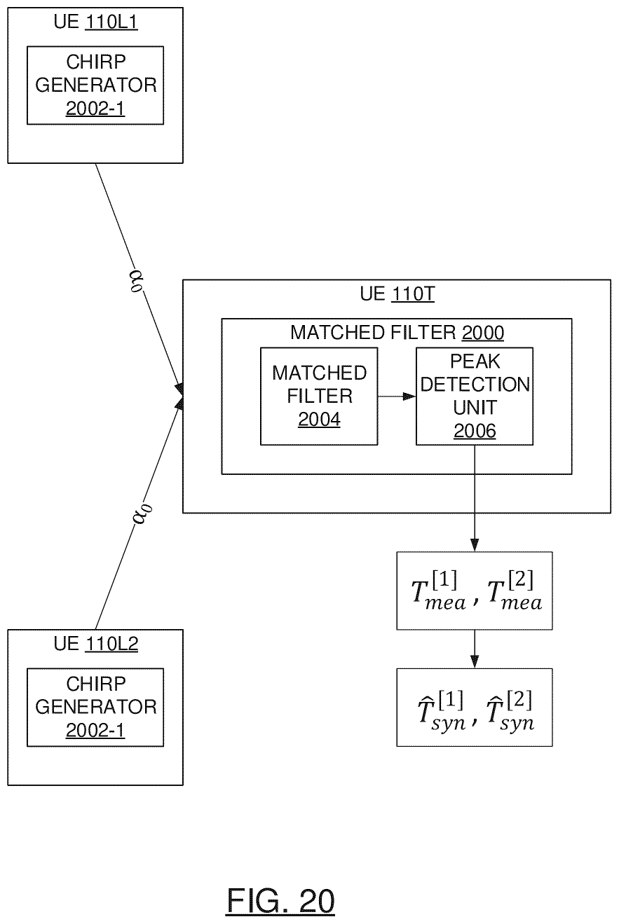

Aspects of the present application relate to a low-complexity receiver 2000 (see FIG. 20) that may allow a target UE 110T to extract timing from a received synchronization chirp signal while the target UE 110T is operating in the low-power mode. Processing, at the receiver 2000, of the received synchronization chirp signal, may be understood to be based on matched filtering of the received synchronization chirp signal. The process of matched filtering is sometimes referenced as “pulse compression.” The process of matched filtering is known to be implemented in the RF domain, thereby leading to a reduction of complexity and power consumption relative to processing carried out in the baseband domain. To operate properly, a matched filter 2004 that is arranged to implement the process of matched filtering is to be matched to the synchronization chirp signal transmitted by the leader UE 110L. Accordingly, it is expected that the target UE 110T will receive at least a part of a synchronization chirp signal configuration (such as an indication of a chirp rate) before the target UE 110T enters into the low-power mode. Responsive to receiving at least a part of the synchronization chirp signal configuration, the target UE 110T may tune the matched filter 2004 for use in the low-power mode. It may, in general, be shown that, when a matched filter is fed with a signal with which the matched filter has been pre-matched, an output envelope will be shaped like a sine function in the time domain. Timing information for the transmitted chirp signal may be extracted by detecting a timing for the peak of the output envelope. Alternatively, the timing information can be extracted from detecting a beat frequency of the synchronization chirp signal after multiplying the received synchronization chirp signal with a conjugate of the transmitted synchronization chirp signal and applying a low-pass filter. In some embodiments, detecting the beat frequency of the synchronization chirp signal may involve carrying out FFT operations over the sampled, RF-processed signal.

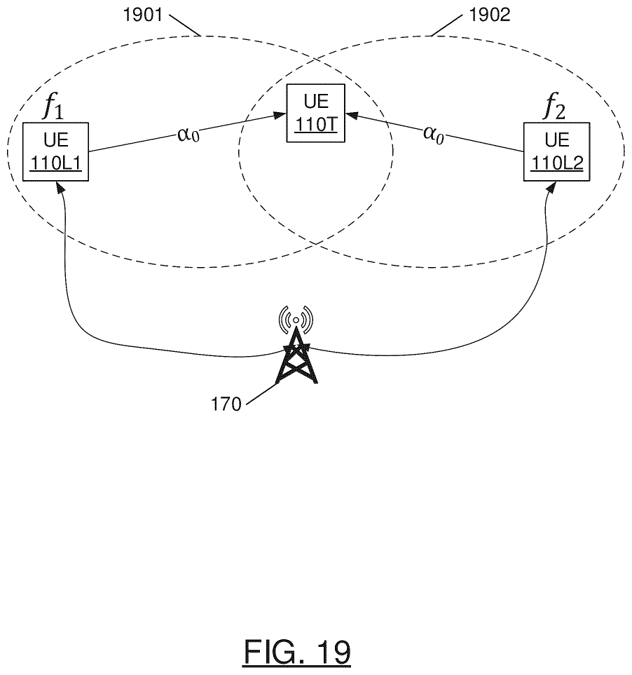

Consider an example illustrated in FIG. 19, where there are two leader UEs 110L1, 110L2 in the vicinity of a target UE 110T that is in low-power mode. The first leader UE 110L1 is associated with a synchronization chirp signal with a first starting frequency, f₁, and a first coverage area 1901. The second leader UE 110L2 is associated with a synchronization chirp signal with a second starting frequency, f₂, and a second coverage area 1902. For the sake of this example, it may be assumed that both synchronization chirp signals start at time zero, i.e., t₁=t₂=0. For the sake of this example, it may also be assumed that the starting frequencies of the synchronization chirp signals transmitted by the two leader UEs 110L1, 110L2, i.e., f₁ and f₂, are well separated.

FIG. 20 illustrates a rudimentary structure for the two leader UEs 110L1, 110L2 and the target UE 110T as well as a representation of the synchronization chirp signals. The first leader UE 110L1 has a first chirp generator 2002-1 for generating the synchronization chirp signals based on a defined configuration. The second leader UE 110L2 has a second chirp generator 2002-2 for generating the synchronization chirp signals based on a defined configuration. Both synchronization chirp signals are illustrated as having a common chirp rate, α₀. At the target UE 110T, the matched filter 2004 is matched to a signal with the common chirp rate, α₀, a zero starting time and a particular starting frequency. Output from the matched filter 2004 is passed to a peak detection unit 2006. The peak detection unit 2006 may be configured to detect peaks of the envelope of the output from the matched filter 2004.

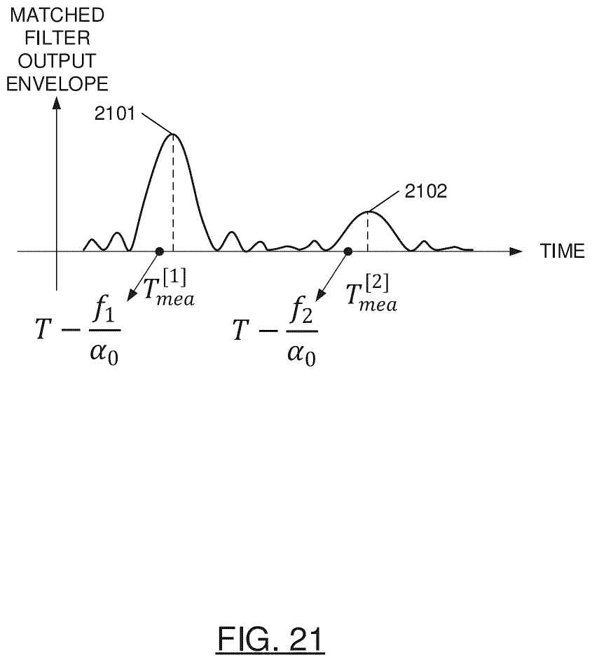

FIG. 21 illustrates an example envelope of the output of the matched filter 2004 in FIG. 20. It may be observed that there is one peak 2101 close to

$$T - \frac{{f}_{1}}{{α}_{0}}$$

and another peak 2102 close to

$$T - \frac{{f}_{2}}{{α}_{0}} .$$

It may also be observed that the peaks are well separated since the starting frequencies of the synchronization chirp signals, f₁ and f₂, are well separated, i.e., an absolute difference, |f₂−f₁|, between the starting frequencies of the synchronization chirp signals is sufficiently large that the respective sine functions do not interfere with each other.

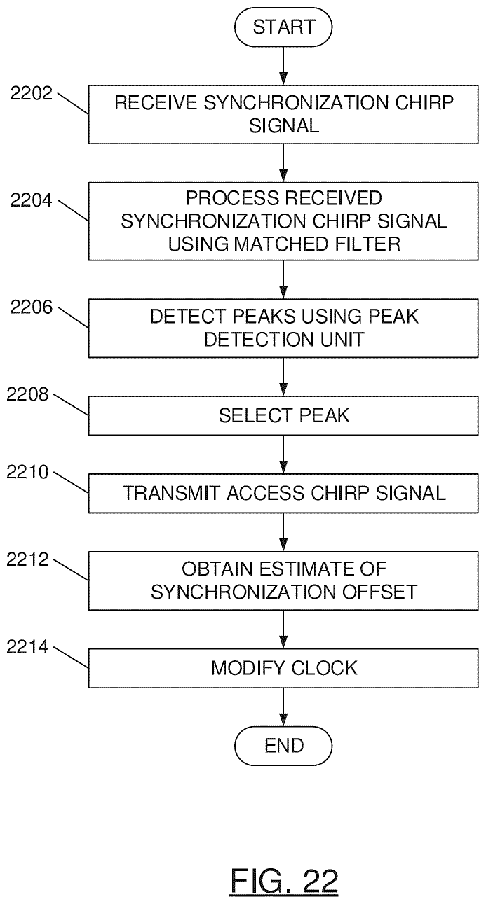

FIG. 22 illustrates steps in an example method of processing a received synchronization chirp signal. Initially, the receiver 2000 of the target UE 110 receives (step 2202) a signal. The target UE 110 may process (step 2204), using the matched filter 2004, the received signal to produce a matched filter output with an envelope (see FIG. 21). The target UE 110 may then obtain (step 2206), using the peak detection unit 2006, so-called measured timing for the peaks. The measured timing may be denoted, Tₘₑₐ^{[1]} and Tₘₑₐ^{[2]}. Notably, it may be shown that

$${T}_{m e a}^{[ i ]} - ( T - \frac{{f}_{i}}{{α}_{0}} ) = {T}_{syn}^{[ i ]} + T o {F}_{i} ,$$

where T_{syn}^{[i]} is the synchronization offset between the target UE 110T and a leader UE 110Li and ToFᵢ is a Time of Flight for a wireless link between the leader UE 110Li and the target UE 110T. As the ToF is assumed to be small, due to the short range of the transmission, the ToF term may be ignored and an estimate,

$${\hat{T}}_{syn}^{[ i ]} = {T}_{m e a}^{[ i ]} - ( T - \frac{{f}_{i}}{{α}_{0}} ) ,$$

of T_{syn}^{[i]} may be used for i=1,2. Notably, the first term, Tₘₑₐ^{[i]}, in the expression for the synchronization offset estimate, \hat{T}_{syn}^{[i]}, is to be obtained by measurement and the second term,

$$( T - \frac{{f}_{t}}{{α}_{0}} ) ,$$

may be determined on the basis of synchronization chirp signal configuration information. Furthermore, since the starting frequencies of the synchronization chirp signals, f₁ and f₂, are well separated, the target UE 110T may determine which peak corresponds to which starting frequency. The target UE 110T may then select one of the peaks and associate the selected peak with the leader UE 110L corresponding to the selected peak. For example, the target UE 110T may select the peak for which the envelope is the largest. The peak for which the envelope is the largest is likely to correspond to the closest leader UE 110L with the smallest ToF. The selecting of the peak for which the envelope is the largest may be shown to lead to a better synchronization offset estimation as ToF appears as an additive error in the synchronization offset estimate, \hat{T}_{syn}^{[i]}.

Upon selecting (step 2208) a peak, the target UE 110T may be considered to have provided itself with some configuration information for the access chirp signal. For a first example, it may be assumed that the first peak has been selected and the first case is in use. Recall that, in the first case, illustrated in FIG. 16, starting frequency is used to differentiate a first synchronization chirp signal 1601 transmitted by a first leader UE from a second synchronization chirp signal 1602 transmitted by a second leader UE.

Upon selecting (step 2208) a peak, the target UE 110T may transmit (step 2210) an access chirp signal with a starting frequency determined on the basis of adding a constant frequency, f_{const}, to a starting frequency, f₁, obtained by selecting the peak. That is, f_{access}=f₁+f_{const}.

Upon obtaining measurements of the access chirp signal, the first leader UE 110L1 can determine that there is a nearby target UE 110T in low-power mode that has decided to be associated with the first leader UE 110L1.

Notably, after the target UE 110T has obtained (step 2212) the estimate, \hat{T}_{syn}^{[i]}, of the synchronization offset between itself and a selected leader UE 110Li, the target UE 110T may modify (step 2214) the clock at the target UE 110T to, thereby, compensate for the synchronization offset. To this end, the target UE 110T changes (step 2214) its time as t′=t±\hat{T}_{syn}^{[i]}, where t′ is the modified time, t is the time before modification and \hat{T}_{syn}^{[i]} is the estimate of the synchronization offset between the target UE 110T and the selected leader UE 110Li.

Aspects of the present application relate to access chirp signal configuration, access chirp signal transmission and access chirp signal measurements. The access chirp signal is transmitted (e.g., step 2210, FIG. 22) by the target UE 110T and measured by a leader UE 110L. Configuration parameters for the access chirp signal may include: a chirp rate; a starting time; a duration; a starting frequency; and a transmit power.

In operation, the TRP 170 may transmit, to the leader UEs 110L and to the target UE 110T before entering the low-power mode, the configuration parameters for the access chirp signal. In one example, the TRP 170 may transmit the configuration parameters using control signaling, such as RRC configuration signaling. One or more configuration parameters for the access chirp signal may be inferred, at the target UE 110T, on the basis of measurements made on received synchronization chirp signals.

In operation in the low-power mode, the target UE 110T transmits (e.g., step 2210, FIG. 22) an access chirp signal based on the configuration.

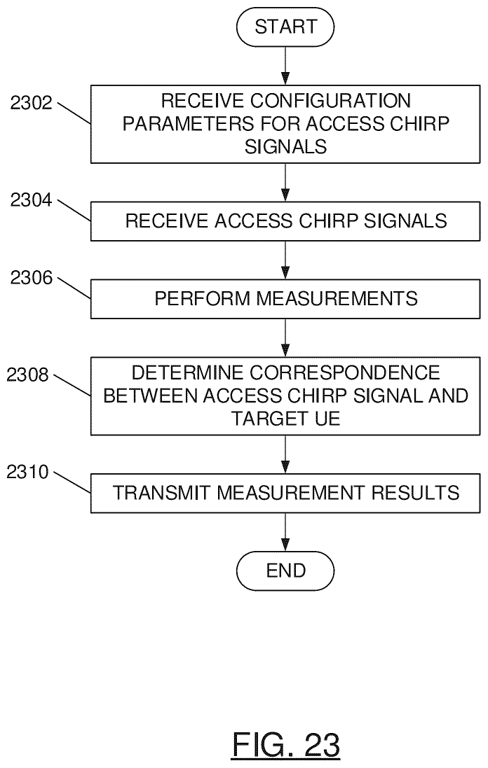

FIG. 23 illustrates example steps in a method of operation for a given leader UE 110L with respect to access chirp signals.

Initially, the given leader UE 110L receives (step 2302), from the TRP 170, the configuration parameters for access chirp signals for a plurality of proximate target UEs 110T. The given leader UE 110L may also receive (step 2302), from the TRP 170, the configuration parameters for synchronization chirp signals.

The given leader UE 110L may, subsequently, receive (step 2304) the access chirp signals transmitted by the proximate target UEs 110T.

The given leader UE 110L may then perform measurements (step 2306) on the received access chirp signals.

From the measurements, the given leader UE 110L may determine (step 2308) the access chirp signal that corresponds to each of the target UEs 110T that have selected to be associated with the given leader UE 110L.

The given leader UE 110L may then transmit (step 2310), to the TRP 170 for further processing, measurement results corresponding to the target UEs 110T that have selected to be associated with the given leader UE 110L.

For access chirp signal transmission, it may be shown that there are advantages to arranging that the transmission (step 2210, FIG. 22) of the access chirp signals by different target UEs 110T are to occur in different domains. The different domains may be shown to allow the leader UE 110L to determine a correspondence between an access chirp signal and a target UE 110 on the basis of performing measurements (step 2306, FIG. 23) on the received access chirp signals.

Such arranging may involve assigning different access chirp signal configuration parameters, such as starting time, starting frequency and/or chirp rate, to different target UEs 110T. It follows that a plurality of mappings may be defined. Each mapping may be understood to associate, with a specific target UE 110T, a specific set of access chirp signal configuration parameters. The mapping may be indexed using a UE ID that is already associated with the specific target UE 110T. In some cases discussed hereinbefore, the starting time and/or the starting frequency of the access chirp signal may be inferred, at the target UE 110T, based on processing measurements of a received synchronization chirp signal. It is notable that an inferred starting time and/or an inferred starting frequency are poor candidates for use when multiplexing signals from a plurality of target UEs 110T. However, the chirp rate domain is always available for use when multiplexing signals from a plurality of target UEs 110T.

For a first example, recall that, in the first case, illustrated in FIG. 16, starting frequency may be used to differentiate a first synchronization chirp signal transmitted by the first leader UE 110L of FIG. 19 from a second synchronization chirp signal transmitted by the second leader UE 110L2 of FIG. 19. Consider a case wherein the starting frequency of the access chirp signal is determined, at the target UE 110T, on the basis of measurements of the synchronization chirp signal. In such a case, it may be shown that the starting frequency of the access chirp signal may not be used to multiplex access chirp signal transmission among a plurality of target UEs 110T. However, the starting time and the chirp rate may be used to multiplex access chirp signal transmission among a plurality of target UEs 110T. Furthermore, an important point is that, although various time-frequency resources may be used for access chirp signal transmission by different target UEs 110T, such resources may be reused throughout the network, since the transmissions are short range.

After transmission (step 2210, FIG. 22) of the access chirp signal by a target UE 110T, the nearby leader UE 110L receives (step 2304, FIG. 23) the access chirp signal and performs measurements (step 2306, FIG. 23) to obtain configuration parameters for the received access chirp signal. The nearby leader UE 110L may also obtain various other parameters that will be mentioned hereinafter. From the configuration parameters obtained for the received access chirp signal, the leader UE 110L may determine whether the received access chirp signal was intended for the leader UE 110L. For example, in the example discussed hereinbefore, the target UE 110T may select the first leader UE 110L1 and, consequently, use an access chirp signal starting frequency based on the first starting frequency, f₁. Upon receiving the access chirp signal at the second leader UE 110L2, the second leader UE 110L2 may determine that the access chirp signal starting frequency is based on the first starting frequency, f₁. Based on determining that the access chirp signal starting frequency is based on the first starting frequency, f₁, the second leader UE 110L2 may ignore the access chirp signal. Upon detecting the access chirp signal, the first leader UE 110L1 may determine that a target UE 110T in the surrounding area has chosen to be associated with the first leader UE 110L1. It is expected that power consumption is not an issue for a leader UE 110L. Accordingly, the measurements performed (step 2306, FIG. 23) at a leader UE 110L may be carried out in the analog RF domain or in the digital baseband domain. The measurements can also be performed (step 2306, FIG. 23) for multiple chirp rates.

The results of the measurements performed at a given leader UE 110L may allow the given leader UE 110L to determine a timing estimation for each target UE 110T associated with the given leader UE 110L. It can be shown that the ToF of the link between the given leader UE 110L and the target UE 110T can be obtained from the timing estimation. Notably, the obtaining of the ToF of the link may only be considered accurate in the case wherein the target UE 110T has modified (step 2214, FIG. 22) its timing after processing (step 2202, FIG. 22) measurements on a synchronization chirp signal received, at the target UE 110T, from the given leader UE 110L.

The results of the measurements performed at a given leader UE 110L may also allow the given leader UE 110L to determine an Angle of Arrival (AoA) of the access chirp signal transmitted by each target UE 110T associated with that leader UE 110L.

After determining (step 2308, FIG. 23) the access chirp signal that corresponds to each of the target UEs 110T that have selected to be associated with the given leader UE 110L, the given leader UE 110L transmits (step 2310, FIG. 23), to the TRP 170 for further processing, measurement results corresponding to the target UEs 110T that have selected to be associated with the given leader UE 110L.

For a second example, it may be assumed that the target UE 110T of FIG. 19 has selected the first leader UE 110L1 after synchronization chirp signal measurement. Again, it may be assumed that the first case, illustrated in FIG. 16, used. Recall that, in the first case, starting frequency may be used to differentiate a first synchronization chirp signal transmitted by the first leader UE 110L of FIG. 19 from a second synchronization chirp signal transmitted by the second leader UE 110L2 of FIG. 19.

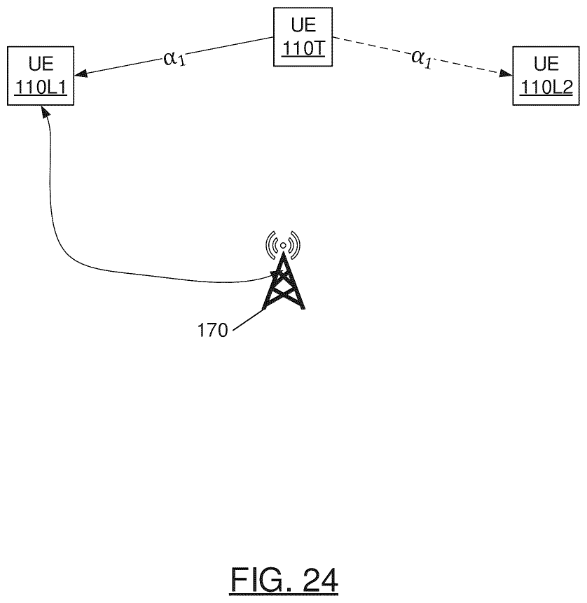

It is expected that the target UE 110T will use f₁+f_{const} as the starting frequency, f_{access}, of the transmitted access chirp signal. A value for f_{const} may have been received, by the target UE 110T before entering low-power mode, in an access chirp signal configuration. A value for f₁ may be obtained, by the target UE 110T, on the basis of measurements of a synchronization chirp signal received from the first leader UE 110L1. A value, α₁, may be used to represent a chirp rate assigned to the target UE 110T for the access chirp signal in this example. Also, a value, t₁, may be used to represent the starting time of the access chirp signal assigned to the target UE 110T. The target UE 110T may transmit, as illustrated in FIG. 24, an access chirp signal with a chirp rate, α₁, a starting frequency f_{access}=f₁+f_{const} and a starting time, t₁.

Both leader UEs 110L1, 110L2 are expected to receive the transmitted access chirp signal and perform measurements. The results of measuring, at both leader UEs 110L1, 110L2, may reveal the starting frequency, f_{access}=f₁+f_{const}, of the received access chirp signal. Consequently, the second leader UE 110L2 may recognize that the target UE 110T that transmitted the access chirp signal did not select to be associated with second leader UE 110L2. Recall that the first starting frequency, f₁, is used as the starting frequency of the synchronization chirp signal transmitted by the first leader UE 110L1. It follows that the target UE 110 bases the starting frequency, f_{access}, of the access chirp signal on the first starting frequency, f₁, to indirectly indicate that the target UE 110 intends to be associated with the first leader UE 110L1. After measurement, the first leader UE 110L1 may determine that there is target UE 110T in the vicinity that would like to be associated with the first leader UE 110L1. Using the measurement results, the first leader UE 110L1 may also obtain the ToF of the link between the first leader UE 110L1 and the target UE 110T. Using the measurement results, the first leader UE 110L1 may further obtain the AoA of the access chirp signal received from the target UE 110T. Subsequently, the first leader UE 110L1 may transmit, to the TRP 170, indications of the measurement of ToF and AoA for the configuration with α₁, f₁ and t₁. Since the TRP 170 maintains configuration parameters for the access chirp signal of different target UEs 110T, the TRP 170 may infer, from the configuration reported with the measurements (e.g., α₁, f₁ and t₁), that the measured values correspond to the target UE 110T.

Aspects of the present application relate to determining a Timing Advance (TA) for a target UE 110T with respect to a TRP 170 while the target UE 110T is operating in a low-power mode. Determining the TA may be based on measurements of an access chirp signal performed by a leader UE 110L associated with the target UE 110T.

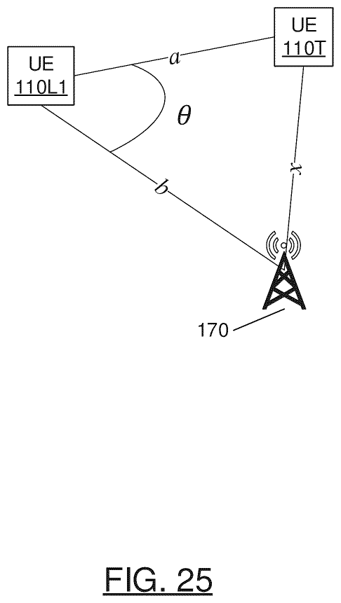

In FIG. 25, there is a TRP 170, a target UE 110T and a leader UE 110L1 to which the target UE 110T has associated itself. It may be assumed that a synchronization chirp signal and an access chirp signal have been transmitted and measured, as discussed hereinbefore. It follows that the TRP 170 has received, from the leader UE 110L1, results of measurement made on the access chirp signal transmitted by the target UE 110T. In FIG. 25, the TRP 170, the target UE 110T and the leader 110L1 may be viewed as vertices of a triangle.

A first link (a sidelink), between the target UE 110T and the leader UE 110L1, may be associated with a value, labelled “a,” for a ToF for the first link. The value for a ToF may be understood to have been obtained, by the leader UE 110L1, on the basis of measurement made on the access chirp signal. It is also expected that the leader UE 110L1 has reported the ToF to the TRP 170. It follows that the TRP 170 maintains the value of a after receiving the report.

Furthermore, a second link, between the TRP 170 and the leader UE 110L1, may be associated with a value, labelled “b,” for a ToF for the second link. Since the leader UE 110L1 is already connected to the TRP 170, it may be assumed that the TRP 170 has already determined the value of b (e.g., during an initial access procedure carried out at the leader UE 110L1, the value of b may have been measured). Recall that the AoA of the access chirp signal sent by the target UE 110T may be measured at the leader UE 110L1. An angle, θ, is illustrated, in FIG. 25, as being formed between the first link and the second link. A value for the angle, θ, may be determined on the basis of the value of the AoA, reported by the leader UE 110L1 to the TRP 170.

A third link, between the TRP 170 and the target 110T, may be associated with a value, labelled “x,” for a ToF for the third link. The TA of the target UE 110T with respect to the TRP 170 may be equal to the ToF, x, of the third link. It follows that, by determining the value of x given the values of a, b and θ, the value of the TA of the target UE 110T with respect to the TRP 170 may be understood to have been determined.

Aspects of the present application relate to using the known Cosine Law to determine the value of x given the values of a, b and θ, x=\sqrt{a²+b²−2ab cos(θ)}. This formula considers the relative position of the nodes in the network. It is possible that the exact value of the angle, θ, is not available. In such cases, the TRP 170 may obtain a range of values for the angle, θ, say [θ₁, θ₂], where θ₁ is one end point of the range and θ₂ is the other end point of the range. Where the end points of a range of values for the angle, θ, are available, the value of x may be approximated using x≈\sqrt{a²+b²−2ab cos(\hat{θ})}, where \hat{θ} is a value representative of the range. For one example, an average of the end points of the range, i.e.,

$$\hat{θ} = \frac{{θ}_{1} + {θ}_{2}}{2}$$

may be used as the value representative of the range.

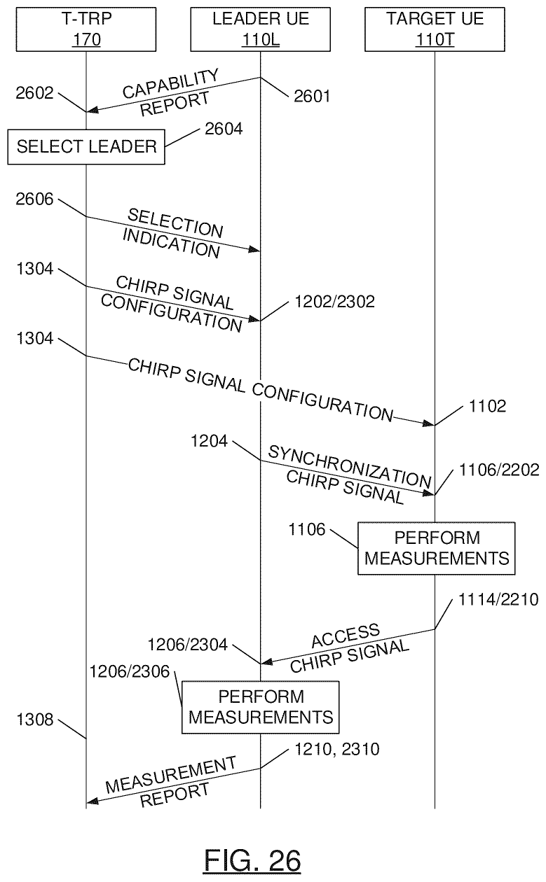

Aspects of the present application relate to signaling exchanges. An example signal flow diagram is illustrated in FIG. 26 for signal flow between a UE 110L, a TRP 170 and a target UE 110T. Initially, the UE 110L transmits, (step 2601), to the TRP 170, a capability report. Subsequently, the TRP 170 receives (step 2602) the capability report from the UE 110L. Notably, at this point, the UE 110L is not yet a leader UE. On the basis of the capability report, the TRP 170 may select (step 2604) the UE 110L to be a leader UE. As noted earlier, the leader need not be a UE. Instead, the leader may be a network node with capabilities suitable for a leader. For simplicity, the leader is referenced as a leader UE throughout the present application.

In general, the TRP 170 may select (step 2604) the leader UEs 110L based on status, features and capabilities such as position, synchronization status and transmit power capability. It may be the case that there is a preference to have one or multiple leader UEs 110L in different geographical parts of a network. In such a case, the position of the leader UEs 110L can be a factor in the leader UE selection (step 2604). To this end, it may be expected that all potential leader UEs 110L provide a capability report to the TRP 170.

Responsive to the selecting (step 2604), the TRP 170 may transmit (step 2606), to the leader UE 110L, a selection indication, indicating that the leader UE 110L has been selected. The selection indication may be transmitted (step 2606) to the leader UE 110L by control signaling (e.g., RRC signaling or MAC-CE). Subsequently, the TRP 170 transmits (step 2608), to the leader UE 110L, information for the configuration of synchronization chirp signal and access chirp signals. The TRP 170 may also transmit (step 2608), to the target UE 110T before the target UE 110T enters the low-power mode, the information for the configuration of the synchronization chirp signal and the access chirp signals. The transmitting (step 2608) of the configuration information may, for one example, be accomplished using RRC configuration signaling. As discussed in view of FIG. 23, the leader UE 110L receives (step 2302) the chirp signal configurations.

The leader UE 110L may then transmit (step 2610) a synchronization chirp signal based on the defined configuration. As discussed in view of FIG. 22, the target UE 110T receives (step 2202) the synchronization chirp signal. As discussed in view of FIG. 11, the target UE 110T performs (step 1106) measurements on the received synchronization chirp signal.

As a result of processing (see steps 2204, 2206 and 2208 in FIG. 22) measurements of the synchronization chirp signal, the target UE 110T may obtain (step 2212) an estimate of synchronization offset and modify (step 2214) the clock at the target UE 110T. Furthermore, a part of the access chirp signal configuration may be inferred from processing (steps 2204, 2206, 2208, FIG. 22) the measurements. The target UE 110T transmits (step 2210, FIG. 22) the access chirp signal based on the configuration. The leader UE 110L receives (step 2304, FIG. 23) the access chirp signal and performs (step 2306, FIG. 23, step 1206, FIG. 12) measurements and prepares a measurement report. Subsequently, the leader UE 110L transmits (step 2310, FIG. 23), to the TRP 170, the measurement report. The TRP 170 receives (step 2612) the measurement report and carries out further processing.

Aspects of the present application relate to the manner in which details of UE clock parameters may be estimated before the estimated clock parameters are used to modify (step 2214, FIG. 22) the clock at the target UE 110T.

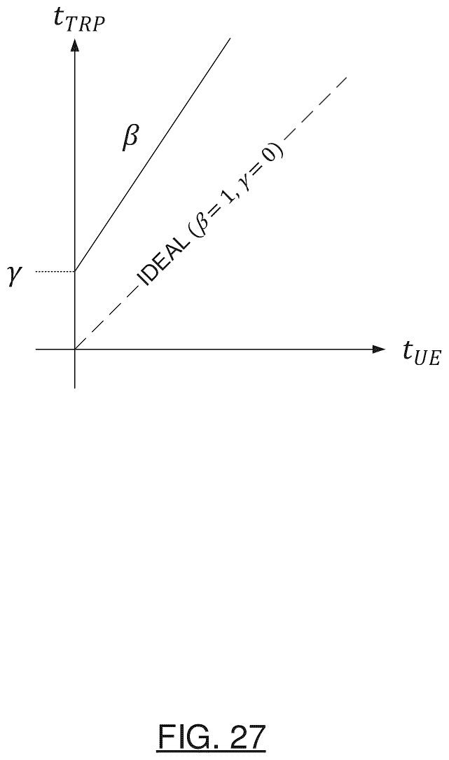

In particular, a linear model, t_{TRP}=βt_{UE}+γ, is considered, where the linear model establishes a relationship between the time at the target UE 110T, t_{UE}, (broadly referenced as “the UE clock”) and the time at the TRP 170, t_{TRP}, (broadly referenced as “the network clock”). The linear model includes model parameters, β and γ. FIG. 27 illustrates the linear model. In the linear model, the model parameter, β, is used to represent a rate of change of a difference between a frequency of the clock at the TRP 170 and a frequency of the clock at the target UE 110T. In the linear model, the model parameter, γ, is used to represent a constant clock drift. Ideally, it would be preferred to have β=1 and γ=0. However, this is not the case in practice. This deviation from the ideal provides incentive for performing synchronization to estimate, and then compensate for, synchronization offset. Aspects of the present application relate to estimating the model parameters, β and γ, on the basis of multiple measurements. Aspects of the present application relate to the target UE 110T in low-power mode obtaining (step 2212, FIG. 22) an estimate of synchronization offset each time a synchronization chirp signal is received (step 2202, FIG. 22) from a leader UE 110L. The target UE 110T may be configured to stack multiple measurements and perform a linear regression to find the model parameters, β and γ. It may be shown that, when a deviation, |β−1|, between the estimated rate of change of the TRP/UE frequency difference, β, and the ideal rate of change of the TRP/UE frequency difference, is larger, the synchronization offset grows faster in time. It follows that, in such cases, synchronization should occur more frequently. Consequently, the frequency of performing synchronization for a target UE 110T may be adjusted in a manner that is proportional to the estimate |β−1|.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method at a first device, the method comprising:
receiving a chirp signal configuration, the chirp signal configuration including configuration information for a first chirp signal;
while the first device is in a low-power mode:
receiving, from a second device, the first chirp signal;
performing measurements on the first chirp signal to obtain an estimated synchronization offset between a first clock at the first device and a second clock at the second device; and
modifying, based on the estimated synchronization offset, the first clock.

2. The method of claim 1, wherein the chirp signal configuration includes second configuration information for a second chirp signal, and the method further comprises:
transmitting the second chirp signal in accordance with the second configuration information.

3. The method of claim 2, further comprising:
inferring, from the measurements on the first chirp signal, a second chirp signal configuration parameter, wherein the transmitting the second chirp signal includes:
transmitting the second chirp signal in accordance with the second chirp signal configuration parameter.

4. The method of claim 1, wherein the performing the measurements on the first chirp signal comprises:
subjecting the first chirp signal to a matched filter.

5. The method of claim 1, wherein the performing the measurements on the first chirp signal comprises:
obtaining a beat frequency of the first chirp signal.

6. An apparatus comprising:
at least one processor; and
a non-transitory computer readable storage medium storing programming, the programming including instructions that, when executed by the at least one processor, cause the apparatus to perform operations including:
receiving a chirp signal configuration, the chirp signal configuration including configuration information for a first chirp signal;
while the apparatus is in a low-power mode:
receiving, from a second device, the first chirp signal;
performing measurements on the first chirp signal to obtain an estimated synchronization offset between a first clock at the apparatus and a second clock at the second device; and
modifying, based on the estimated synchronization offset, the first clock.

7. The apparatus of claim 6, wherein the chirp signal configuration includes second configuration information for a second chirp signal, the operations further comprising:
transmitting the second chirp signal in accordance with the second configuration information.

8. The apparatus of claim 7, the operations further comprising:
inferring, from the measurements on the first chirp signal, a second chirp signal configuration parameter, wherein the transmitting the second chirp signal includes:
transmitting the second chirp signal in accordance with the second chirp signal configuration parameter.

9. The apparatus of claim 6, wherein the performing the measurements on the first chirp signal comprises:
subjecting the first chirp signal to a matched filter.

10. The apparatus of claim 6, wherein the performing the measurements on the first chirp signal comprises:
obtaining a beat frequency of the first chirp signal.

11. A method at a first device, the method comprising:
receiving a chirp signal configuration, the chirp signal configuration including configuration information for a first chirp signal;
while a second device is in a low-power mode:
transmitting, to the second device, the first chirp signal in accordance with the configuration information for the first chirp signal;
receiving, from the second device, a second chirp signal;
obtaining measurements on the second chirp signal to determine that the second chirp signal is intended for the first device; and
transmitting, to a third device, a measurement report based on the measurements on the second chirp signal.

12. The method of claim 11, further comprising:
transmitting, to the third device, a capability report.

13. The method of claim 12, wherein the capability report indicates at least one of: a position of the first device, a synchronization status of the first device, or a transmit power capability of the first device.

14. The method of claim 11, further comprising:
transmitting, to the second device before the second device enters the low-power mode and before the transmitting the first chirp signal, the configuration information for the first chirp signal.

15. The method of claim 11, further comprising:
transmitting, to the second device before the second device enters the low-power mode, second configuration information for the second chirp signal.

16. An apparatus comprising:
at least one processor; and
a non-transitory computer readable storage medium storing programming, the programming including instructions that, when executed by the at least one processor, cause the apparatus to perform operations including:
receiving a chirp signal configuration, the chirp signal configuration including configuration information for a first chirp signal;
while a second device is in a low-power mode:
transmitting, to the second device, the first chirp signal in accordance with the configuration information for the first chirp signal;
receiving, from the second device, a second chirp signal;
obtaining measurements on the second chirp signal to determine that the second chirp signal is intended for the apparatus; and
transmitting, to a third device, a measurement report based on the measurements on the second chirp signal.

17. The apparatus of claim 16, the operations further comprising:
transmitting, to the third device, a capability report.

18. The apparatus of claim 17, wherein the capability report indicates at least one of: a position of the apparatus, a synchronization status of the apparatus, or a transmit power capability of the apparatus.

19. The apparatus of claim 16, the operations further comprising:
transmitting, to the second device before the second device enters the low-power mode and before the transmitting the first chirp signal, the configuration information for the first chirp signal.

20. The apparatus of claim 16, the operations further comprising:
transmitting, to the second device before the second device enters the low-power mode, second configuration information for the second chirp signal.
